(19) United States
(12) Patent Application Publication
(10) Pub. No.: US 2023/0334363 A1
(43) Pub. Date: Oct. 19, 2023

(54) EVENT PREDICTION BASED ON MACHINE LEARNING AND ENGINEERING ANALYSIS TOOLS

(71) Applicant: Israel Aerospace Industries Ltd., Lod (IL)

(72) Inventors: Laura BOUAZIZ, Ra'anana (IL); Sarit ASSARAF, Modi'in (IL)

(21) Appl. No.: 18/044,653

(22) PCT Filed: Aug. 17, 2021
(86) PCT No.: PCT/IL2021/051000

§ 371 Date: Mar. 9, 2023

(30) Foreign Application Priority Data
Sep. 16, 2020 (IL) 277424

(51) Int. Cl. G06N 20/00

(52) U.S. Cl. CPC G06N 20/00

(57) ABSTRACT

A computerized system performs training of machine learning models to enable prediction of occurrence of event(s), which are associated with a system to be analyzed. The system performs the following: (a) provide trained Anomaly Detection Model(s). (b) provide Analysis Tool(s), configured to provide quantitative indications of the event(s). The quantitative indications of the event(s) are based on input events(s). (c) receive first unlabeled data associated with the system, where this data comprise sensor data, (d) input the first unlabeled data to the Anomaly Detection Model(s). (d) generate, using the Anomaly Detection Models, indications of occurrence of the input event(s), based on the first unlabeled data, (e) input the indications of the occurrence into the Tool(s). (f) generate, using the Tools, quantitative indications of the events, based the indications of the occurrence, (g) generate, using the quantitative indications, labels for the first unlabeled data.

### TECHNICAL FIELD

The presently disclosed subject matter relates to predictive maintenance.

### BACKGROUND

Predictive maintenance techniques are designed to help determine the condition of in-service equipment in order to estimate when maintenance should be performed. This approach promises cost savings over routine or time-based preventive maintenance, because tasks are performed only when warranted. Thus, it is regarded as condition-based maintenance carried out as suggested by estimations of the degradation state of an item (see Wikipedia ®). It can also in some cases prevent unexpected failures. Such techniques are in some cases particularly useful for complex and high-cost systems, such as for example aerospace systems and power systems.

The field of Reliability, Availability, Maintainability and Safety (RAMS) makes use of various engineering analysis tools. A non-limiting example is Event Tree Analysis, e.g. Failure Tree Analysis (FTA).

In some examples, there are generated data that are associated with systems and with their sub-systems and components. A non-limiting example is sensor data associated with the systems.

Pat. application publication WO2012129561 (publication date 27 Sep. 2012) discloses a dynamic risk analysis methodology that uses alarm databases. The methodology consists of three steps: (i) tracking of abnormal events over an extended period of time, (ii) event-tree and set- theoretic formulations to compact the abnormal event data, and (iii) Bayesian analysis to calculate the likelihood of the occurrence of incidents. The set-theoretic structure condenses the event paths to a single compact data record. The Bayesian analysis method utilizes near-misses from distributed control system and emergency shutdown system databases to calculate the failure probabilities of safety, quality, and operability systems (SQOSs), and probabilities of occurrence of incidents and accounts for the interdependences among the SQOSs using copulas.

Pat. application publication US10248490 (publication date 2 Apr. 2019) discloses systems and methods for predictive reliability mining are provided that enable predicting of unexpected emerging failures in future without waiting for actual failures to start occurring in significant numbers. Sets of discriminative Diagnostic Trouble Codes (DTCs) from connected machines in a population are identified before failure of the associated parts. A temporal conditional dependence model based on the temporal dependence between the failure of the parts from past failure data and the identified sets of discriminative DTCs is generated. Future failures are predicted based on the generated temporal conditional dependence and root cause analysis of the predicted future failures is performed for predictive reliability mining. The probability of failure is computed based on both occurrence and non-occurrence of DTCs.

Acknowledgement of the above references herein is not to be inferred as meaning that these are in any way relevant to the patentability of the presently disclosed subject matter.

### GENERAL DESCRIPTION

According to a first aspect of the presently disclosed subject matter there is presented a method of training machine learning models to enable prediction of occurrence of one or more events to be predicted, the one or more events to be predicted being associated with a system to be analyzed, comprising, using a processing circuitry to perform the following:
a. provide one or more trained Machine Learning Anomaly Detection Models;
b. provide one or more Analysis Tools, configured to provide quantitative indications of the one or more events to be predicted,
   wherein each event to be predicted of the one or more events is associated with one or more input events,
   wherein the quantitative indications of the one or more events to be predicted are based on the one or more input events;
c. receive first unlabeled data associated with the system to be analyzed, wherein the first unlabeled data comprises at least sensor data associated with one or more sensors;
d. input the first unlabeled data to the one or more trained Machine Learning Anomaly Detection Models;
e. generate, using the one or more trained Machine Learning Anomaly Detection Models, indications of occurrence of the one or more input events, based on the first unlabeled data;
f. input the indications of the occurrence of the one or more input events into the one or more Analysis Tools;
g. generate, using the one or more Analysis Tools, quantitative indications of the one or more events to be predicted, based at least on the indications of the occurrence of the one or more input events; and
h. generate, using the quantitative indications of the one or more events to be predicted, labels for the first unlabeled data, thereby deriving first labeled data from the first unlabeled data,
whereby the first labeled data is usable to enable training one or more Machine Learning Event Prediction Models associated with the system to be analyzed, wherein the one or more trained Machine Learning Event Prediction Models are configured to predict, based on third unlabeled data, predicted third probabilities of occurrence of the one or more events to be predicted, wherein each predicted third probability of the third probabilities is associated with a predicted time of the occurrence of the event.

In addition to the above features, the method according to this aspect of the presently disclosed subject matter can include one or more of features (i) to (xxxvi) listed below, in any desired combination or permutation which is technically possible:
(i) the quantitative indications of the one or more events to be predicted comprise second probabilities of occurrence of the one or more events to be predicted.
(ii) the indications of the occurrence of the one or more input events comprise Boolean values.
(iii) the indications of the occurrence of the one or more input events are associated with indications of anomalies in the first unlabeled data.
(iv) the first unlabeled data is associated with a timestamp, and the probabilities of occurrence of the one or more events to be predicted are associated with the timestamp.
(v) a single indication of occurrence of the one or more input events is associated with a plurality of timestamps,
   wherein a single quantitative indication of the one or more events to be predicted is associated with the plurality of timestamps.
(vi) each input event of the one or more input events is associated with a trained Machine Learning Anomaly Detection Model of the one or more trained Machine Learning Anomaly Detection Models.
(vii) the first unlabeled data comprises condition parameters data, associated with at least one of characteristics of the system to be analyzed and the condition parameters data comprises data deriving from within the system to be analyzed and data deriving from without the system.
(viii) the one or more trained Machine Learning Anomaly Detection Models are configured such that an indication of the occurrence of each input event of the one or more input events is based on sensor data associated with a sub-set of the one or more sensors.
(ix) the configuration of the one or more trained Machine Learning Anomaly Detection Models is based on the one or more Analysis Tools.
(x) the first unlabeled data, the second unlabeled data and the third unlabeled data are distinct portions of a single data set.
(xi) the one or more analysis Tools comprise default first probabilities of occurrence of the one or more input events,
   wherein said step (g) is further based at least on the on the default first probabilities of occurrence of the one or more input events.
(xii) the default first probabilities of occurrence of the one or more input events are input into the one or more analysis Tools.
(xiii) the step (e) further comprises generating, based on the indications of occurrence of the one or more input events and the first unlabeled data, data-based factors corresponding respectively with the indications of occurrence of the one or more input events,
   wherein the step (g) comprises modifying the default first probabilities of occurrence of the one or more input events, based on corresponding data-based factors, thereby deriving updated first probabilities of occurrence of the one or more input events.
(xiv) the one or more Analysis Tools are further configured to provide qualitative indications of the one or more events to be predicted.
(xv) the qualitative indications of the one or more events to be predicted comprise indications of occurrence of the one or more events to be predicted, wherein the step (g) comprises:
   (i) generating, using the one or more Analysis Tools, the indications of occurrence of the one or more events to be predicted;
   (ii) inputting the indications of occurrence of the one or more events to be predicted into the one or more Analysis Tools; and
   (iii) performing the generating of the quantitative indications of the one or more events to be predicted in respect of events to be predicted that are associated with positive indications of occurrence of the one or more events to be predicted.
(xvi) the indications of occurrence of the one or more events to be predicted comprise Boolean values.
(xvii) each predicted third probability of the predicted third probabilities is associated with a given time of the occurrence.
(xviii) the one or more Machine Learning Event Prediction Models comprises one or more Machine Learning Failure Prediction Models,
   wherein the one or more trained Machine Learning Event Prediction Models comprises one or more trained Machine Learning Failure Prediction Models.
(xix) the step (a) comprises:
   training one or more Machine Learning Anomaly Detection Models, utilizing second unlabeled data, thereby generating the one or more trained Machine Learning Anomaly Detection Models.
(xx) the one or more Machine Learning Anomaly Detection Models comprises at least one of a One Class Classification Support Vector Machine (OCC SVM), a Local Outlier Factor (LOF), and a One Class Classification Random Forest (OCC RF).
(xxi) The method of any one of claims 1 to 22, wherein the Machine Learning Event Prediction Models comprises at least one of a Bayesian network and a Deep Neural Network.
(xxii) the Analysis Tool comprises Event Tree Analysis.
(xxiii) the one or more events to be predicted comprise one or more failures.
(xxiv) the one or more Analysis Tools comprises one or more Reliability, Availability, Maintainability and Safety (RAMS) Analysis Tools.
(xxv) the RAMS Analysis Tool comprises Failure Tree Analysis.
(xxvi) the one or more events to be predicted are based on logic combinations of input events.
(xxvii) the one or more events to be predicted comprise one or more Top Events.
(xxviii)the one or more input events comprise one or more Basic Events.
(xxix) the system to be analyzed is one of an aircraft system and a spacecraft system.
(xxx) the training of the Machine Learning Anomaly Detection Model(s) is unsupervised.
(xxxi) the training of the Machine Learning Event Prediction Model(s) is supervised.
(xxxii) whereby the quantitative indications of the one or more events to be predicted are usable as a diagnostic tool for the first unlabeled data.
(xxxiii)the method further comprises performing a repetition of steps (a) to (h).
(xxxiv)the performance of the repetition is after at least one of a defined time interval, a system repair, a system overhaul and a system failure.
(xxxv) the computerized system is operatively coupled to at least one external system, wherein the outputting of the predicted third probabilities comprises at least one of: sending an alert to at least one external system, sending an action command to the at least one external system.
(xxxvi)the processing circuitry comprises a processor and a memory, the computerized system comprises a data storage, the computerized system is operatively coupled to at least one sensor, the computerized system is operatively coupled to at least one external system.

According to a second aspect of the presently disclosed subject matter there is presented a method of training machine learning models to enable prediction of occurrence of one or more events to be predicted, the one or more events to be predicted being associated with a system to be analyzed, comprising, using a processing circuitry to perform the following:
a. receive first labeled data associated with the system to be analyzed, wherein the first labeled data is generated using the following steps:
   i. provide one or more trained Machine Learning Anomaly Detection Models;
   ii. provide one or more Analysis Tools, configured to provide quantitative indications of the one or more events to be predicted,
      wherein each event to be predicted of the one or more events is associated with one or more input events,
      wherein the quantitative indications of the one or more events to be predicted are based on the one or more input events;
   iii. receive first unlabeled data associated with the system to be analyzed, wherein the first unlabeled data comprises at least sensor data associated with one or more sensors;
   iv. input the first unlabeled data to the one or more trained Machine Learning Anomaly Detection Models;
   v. generate, using the one or more trained Machine Learning Anomaly Detection Models, indications of occurrence of the one or more input events, based on the first unlabeled data;
   vi. input the indications of the occurrence of the one or more input events into the one or more Analysis Tools;
   vii. generate, using the one or more Analysis Tools, quantitative indications of the one or more events to be predicted, based at least on the indications of the occurrence of the one or more input events; and
   viii. generate, using the quantitative indications of the one or more events to be predicted, labels for the first unlabeled data, thereby deriving the first labeled data from the first unlabeled data; and
b. train one or more Machine Learning Event Prediction Models associated with the system to be analyzed, utilizing the first labeled data, thereby generating one or more trained Machine Event Failure Prediction Models,
wherein the one or more trained Machine Learning Event Prediction Models are configured to predict, based on third unlabeled data, predicted third probabilities of occurrence of the one or more events to be predicted, wherein each predicted third probability of the third probabilities is associated with a predicted time of the occurrence of the event.

In addition to the above features, the method according to this aspect of the presently disclosed subject matter can include feature (xxxvii) listed below, in any desired cbination or permutation which is technically possible:
(xxxvii) further comprising performing the following:
   A. input the third unlabeled data into the one or more trained Machine Learning Event Prediction Models;
   B. generate, using the one or more trained Machine Learning Event Prediction Models, the predicted third probabilities of occurrence of the one or more events to be predicted, based on the third unlabeled data; and
   C. output the predicted third probabilities.

According to a third aspect of the presently disclosed subject matter there is presented a method of training machine learning models to enable prediction of occurrence of one or more events to be predicted, the one or more events to be predicted being associated with a system to be analyzed, comprising, using a processing circuitry to perform the following:
a. provide one or more trained Machine Learning Anomaly Detection Models;
b. provide one or more Analysis Tools, configured to provide quantitative indications of the one or more events to be predicted,
   wherein each event to be predicted of the one or more events is associated with one or more input events,
   wherein the quantitative indications of the one or more events to be predicted are based on the one or more input events;
c. receive first unlabeled data associated with the system to be analyzed, wherein the first unlabeled data comprises at least sensor data associated with one or more sensors;
d. input the first unlabeled data to the one or more trained Machine Learning Anomaly Detection Models;
e. generate, using the one or more trained Machine Learning Anomaly Detection Models, indications of occurrence of the one or more input events, based on the first unlabeled data;
f. input the indications of the occurrence of the one or more input events to the one or more Analysis Tools;
g. generate, using the one or more Analysis Tools, quantitative indications of occurrence of the one or more events to be predicted, based at least on the indications of the occurrence of the one or more input events;
h. generate, using the quantitative indications of the one or more events to be predicted, labels for the first unlabeled data, thereby deriving first labeled data from the first unlabeled data; and
i. train one or more Machine Learning Event Prediction Models associated with the system to be analyzed, utilizing the first labeled data, thereby generating one or more trained Machine Learning Event Prediction Models,
wherein the one or more trained Machine Learning Event Prediction Models are configured to predict, based on third unlabeled data, predicted third probabilities of occurrence of the one or more events to be predicted, wherein each predicted third probability of the third probabilities is associated with a predicted time of the occurrence of the event.

According to a fourth aspect of the presently disclosed subject matter there is presented a method of predicting occurrence of one or more events to be predicted, the one or more events to be predicted being associated with a system to be analyzed, comprising, using a processing circuitry to perform the following:
a. input third unlabeled data into one or more trained Machine Learning Event Prediction Models,
   wherein the one or more trained Machine Learning Event Prediction Models are generated by performing the following:
      i. provide one or more trained Machine Learning Anomaly Detection Models;
      ii. provide one or more Analysis Tools, configured to provide quantitative indications of the one or more events to be predicted,
         wherein each event to be predicted of the one or more events is associated with one or more input events,
         wherein the quantitative indications of the one or more events to be predicted are based on one or more input events;
      iii. receive first unlabeled data associated with the system to be analyzed, wherein the first unlabeled data comprises at least sensor data associated with one or more sensors;
      iv. input the first unlabeled data to the one or more trained Machine Learning Anomaly Detection Models;
      v. generate, using the one or more trained Machine Learning Anomaly Detection Models, indications of occurrence of the one or more input events, based on the first unlabeled data;
      vi. input the indications of the occurrence of the one or more input events to the one or more Analysis Tools;
      vii. generate, using the one or more Analysis Tools, quantitative indications of occurrence of the one or more events to be predicted, based at least on the indications of the occurrence of the one or more input events;
      viii. generate, using the quantitative indications of the one or more events to be predicted, labels for the first unlabeled data, thereby deriving first labeled data from the first unlabeled data; and
      ix. train one or more Machine Learning Event Prediction Models associated with the system to be analyzed, utilizing the first labeled data, thereby generating the one or more trained Machine Learning Event Prediction Models; and
b. generate, using the one or more trained Machine Learning Event Prediction Models, predicted third probabilities of occurrence of the one or more events to be predicted, based on the third unlabeled data,
   wherein each predicted third probability of the third probabilities is associated with a predicted time of the occurrence of the event; and
c. output the predicted third probabilities.

According to a fourth aspect of the presently disclosed subject matter there is presented a method of predicting occurrence of one or more events to be predicted, the one or more events to be predicted being associated with a system to be analyzed, comprising, using a processing circuitry to perform the following:
a. provide one or more trained Machine Learning Anomaly Detection Models;
b. provide one or more Analysis Tools, configured to provide quantitative indications of the one or more events to be predicted,
   wherein each event to be predicted of the one or more events is associated with one or more input events,
   wherein the quantitative indications of the one or more events to be predicted are based on one or more input events;
c. receive first unlabeled data associated with the system to be analyzed, wherein the first unlabeled data comprises at least sensor data associated with one or more sensors;
d. input the first unlabeled data to the one or more trained Machine Learning Anomaly Detection Models;
e. generate, using the one or more trained Machine Learning Anomaly Detection Models, indications of occurrence of the one or more input events, based on the first unlabeled data;
f. input the indications of the occurrence of the one or more input events to the one or more Analysis Tools;
g. generate, using the one or more Analysis Tools, quantitative indications of occurrence of the one or more events to be predicted, based at least on the indications of the occurrence of the one or more input events;
h. generate, using the quantitative indications of the one or more events to be predicted, labels for the first unlabeled data, thereby deriving first labeled data from the first unlabeled data;
i. train one or more Machine Learning Event Prediction Models associated with the system to be analyzed, utilizing the first labeled data, thereby generating one or more trained Machine Learning Event Prediction Models;
j. input third unlabeled data into the one or more trained Machine Learning Event Prediction Models;
k. generate, using the one or more trained Machine Learning Event Prediction Models, predicted third probabilities of occurrence of the one or more events to be predicted, based on the third unlabeled data, wherein each predicted third probability of the third probabilities is associated with a predicted time of the occurrence of the event; and
l. output the predicted third probabilities.

The second to fifth aspects of the disclosed subject matter can optionally include one or more of features (i) to (xxxvii) listed above, mutatis mutandis, in any desired combination or permutation which is technically possible.

According to another aspect of the presently disclosed subject matter there is provided a non-transitory computer readable storage medium tangibly embodying a program of instructions that when executed by a computer, cause the computer to perform the method of any one of the second to fourth aspects of the disclosed subject matter.

According to another aspect of the presently disclosed subject matter there is provided a computerized system configured to perform training of machine learning models to enable prediction of occurrence of one or more events to be predicted, the one or more events to be predicted being associated with a system to be analyzed, the computerized system comprising a processing circuitry configured to perform the method of any one of the second to third aspects of the disclosed subject matter.

According to another aspect of the presently disclosed subject matter there is provided a computerized system configured to predict occurrence of one or more events to be predicted, the one or more events to be predicted being associated with a system to be analyzed, the computerized system comprising a processing circuitry configured to perform the method of the fourth aspect of the disclosed subject matter.

The computerized systems and the non-transitory computer readable storage media, disclosed herein according to various aspects, can optionally further comprise one or more of features (i) to (xxxiii) listed above, mutatis mutandis, in any technically possible combination or permutation.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates schematically an example generalized view of a methodology for training and running event prediction models, in accordance with some embodiments of the presently disclosed subject matter;

FIG. 2 schematically illustrates an example generalized view of a RAMS Analysis Tool, in accordance with some embodiments of the presently disclosed subject matter;

FIG. 3A schematically illustrates an example generalized schematic diagram of a failure prediction system, in accordance with some embodiments of the presently disclosed subject matter;

FIG. 3B schematically illustrates an example generalized schematic diagram of storage, in accordance with some embodiments of the presently disclosed subject matter;

FIG. 4A schematically illustrates an example generalized data flow for models training, in accordance with some embodiments of the presently disclosed subject matter;

FIG. 4B schematically illustrates an example generalized data flow for utilizing Machine Learning Anomaly Detection Models, in accordance with some embodiments of the presently disclosed subject matter;

FIG. 4C schematically illustrates an example generalized data flow for utilizing Machine Learning Anomaly Detection Models, in accordance with some embodiments of the presently disclosed subject matter;

FIG. 4D schematically illustrates an example generalized data flow for utilizing Analysis Tool(s), in accordance with some embodiments of the presently disclosed subject matter;

FIG. 5A schematically illustrates an exemplary generalized data flow for models training, in accordance with some embodiments of the presently disclosed subject matter;

FIG. 5B schematically illustrates an exemplary generalized data flow for utilizing Machine Learning Event Prediction Models, in accordance with some embodiments of the presently disclosed subject matter;

FIG. 6 schematically illustrates an example generalized view of unlabeled data, in accordance with some embodiments of the presently disclosed subject matter;

FIG. 7 schematically illustrates an example generalized view of labeled data, in accordance with some embodiments of the presently disclosed subject matter;

FIG. 8A illustrates one example of a generalized flow chart diagram, of a flow of a process or method, for training of an anomaly detection model, in accordance with some embodiments of the presently disclosed subject matter;

FIG. 8B illustrates one example of a generalized flow chart diagram, of a flow of a process or method, for generation of data labels, in accordance with some embodiments of the presently disclosed subject matter;

FIG. 9A illustrates one example of a generalized flow chart diagram, of a flow of a process or method, for training of models, in accordance with certain embodiments of the presently disclosed subject matter; and

FIG. 9B illustrates a generalized exemplary flow chart diagram, of the flow of a process or method, for event prediction, in accordance with certain embodiments of the presently disclosed subject matter.

### DETAILED DESCRIPTION

In the drawings and descriptions set forth, identical reference numerals indicate those components that are common to different embodiments or configurations.

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

Unless specifically stated otherwise, as apparent from the following discussions, it is appreciated that throughout the specification discussions utilizing terms such as “providing”, “receiving”, “inputting”, “generating”, “deriving”, “outputting” or the like, refer to the action(s) and/or process(es) of a computer that manipulate and/or transform data into other data, said data represented as physical, e.g. such as electronic or mechanical quantities, and/or said data representing the physical objects. The term “computer” should be expansively construed to cover any kind of hardware-based electronic device with data processing capabilities including a personal computer, a server, a computing system, a communication device, a processor or processing unit (e.g. digital signal processor (DSP), a microcontroller, a microprocessor, a field programmable gate array (FPGA), an application specific integrated circuit (ASIC), etc.), and any other electronic computing device, including, by way of non-limiting example, system 305,and processing circuitry 310, disclosed in the present application.

The operations in accordance with the teachings herein may be performed by a computer specially constructed for the desired purposes, or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

The terms “non-transitory memory” and “non-transitory storage medium” used herein should be expansively construed to cover any volatile or non-volatile computer memory suitable to the presently disclosed subject matter.

As used herein, the phrase “for example,” “such as”, “for instance” and variants thereof describe non-limiting embodiments of the presently disclosed subject matter. Reference in the specification to “one case”, “some cases”, “other cases”, “one example”, “some examples”, “other examples”, or variants thereof, means that a particular described method, procedure, component, structure, feature or characteristic described in connection with the embodiment(s) is included in at least one embodiment of the presently disclosed subject matter, but not necessarily in all embodiments. The appearance of the same term does not necessarily refer to the same embodiment(s) or example(s).

Usage of conditional language, such as “may”, “might”, or variants thereof, should be construed as conveying that one or more examples of the subject matter may include, while one or more other examples of the subject matter may not necessarily include, certain methods, procedures, components and features. Thus such conditional language is not generally intended to imply that a particular described method, procedure, component or circuit is necessarily included in all examples of the subject matter. Moreover, the usage of non-conditional language does not necessarily imply that a particular described method, procedure, component or circuit is necessarily included in all examples of the subject matter.

It is appreciated that certain embodiments, methods, procedures, components or features of the presently disclosed subject matter, which are, for clarity, described in the context of separate embodiments or examples, may also be provided in combination in a single embodiment or examples. Conversely, various embodiments, methods, procedures, components or features of the presently disclosed subject matter, which are, for brevity, described in the context of a single embodiment, may also be provided separately or in any suitable sub-combination.

It should also be noted that each of the figures herein, and the text discussion of each figure, describe one aspect of the presently disclosed subject matter in an informative manner only, by way of non-limiting example, for clarity of explanation only. It will be understood that that the teachings of the presently disclosed subject matter are not bound by what is described with reference to any of the figures or described in other documents referenced in this application.

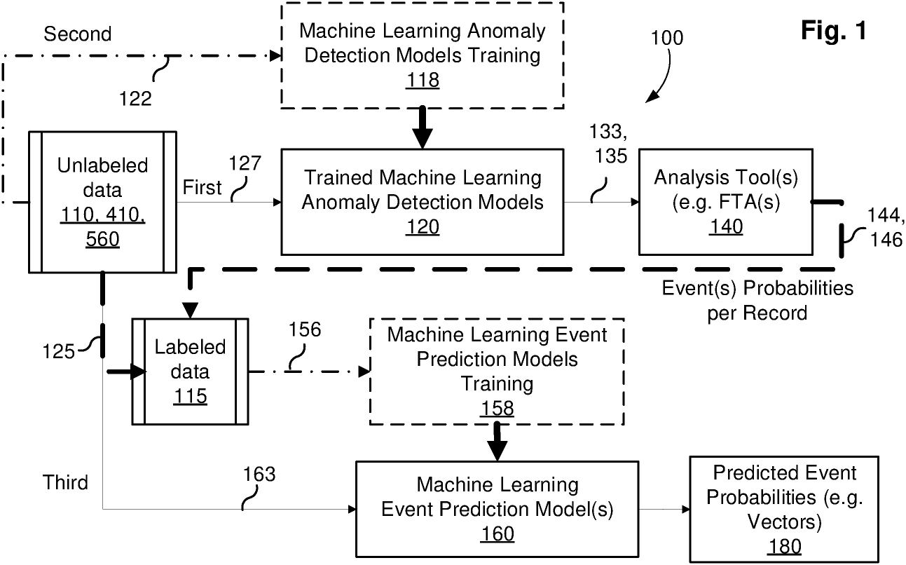

Bearing this in mind, attention is drawn to FIG. 1, schematically illustrating an example generalized view of a methodology for training and running event prediction models, in accordance with some embodiments of the presently disclosed subject matter. Example methodology 100 discloses a data flow between functional components such as models, and engineering analysis tools.

In some examples, the methodology 100 is applicable to systems for which Reliability, Availability, Maintainability and Safety (RAMS) engineering analysis tools 140 exist, and for which relevant collectable data 110, 410, 560 exist. Non-limiting examples of such a system, used herein only for ease of exposition, include complex systems such as aircraft systems and spacecraft systems - e.g. an aircraft engine, landing gear, various control systems for e.g. control surfaces such as rudders, ailerons and flaps etc. In some examples, such collectable data is referred to herein also as raw data 110, 410, 560. In some examples, such systems, for which analysis and prediction of events is to be performed, are referred to herein also as systems to be analyzed, analyzed systems, systems to be investigated, and investigated systems. In some examples, such collectable or acquired data 110, 410, 560 comprise condition parameters data, which are associated with characteristics of the system that is being analyzed, and/or are associated with characteristics of operation of this system. In some examples, such condition parameters data document operating condition of a flight, and/or in-flight characteristics. In some examples, such condition parameters data include various data that can be recorded. Examples of such data include sensor data recorded by one or more sensors, which are associated with the particular system that will be analyzed. In some examples, the sensor data is continuous data (pressure, temperature, altitude, speed etc.).

Additional examples of recorded data include data of a position (e.g. a flap position, valve position), or general information that is not sensor data, such as “flight phase” or “auto-pilot mode” or various state data, as non-limiting examples.

In some examples, the condition parameters data comprise data deriving from within the system and/or data deriving from without the system. In some examples, such data are also referred to herein as data that is internal or external to the system, or as external and internal parameters. One example of internal data is pressure inside of an airplane cabin. Examples of external data include data on system environment that surrounds the system to be analyzed, e.g. the external or outside air pressure that is external to an aircraft.

In some examples, each set of captured or collected data 110, 410, 560 is associated with a data time or timestamp Ti, e.g. the time of acquisition or recording of the data, for example a time of data recording by a particular sensor.

In some examples, it is desirable to predict the occurrence of system-related events, e.g. system behaviors of various types, before they occur, so as to enable the performance of relevant actions in a timely manner before the event occurrence. An example of such events is problematic and undesirable events such as failures of systems and/or of their sub-systems. In the field of predictive maintenance, prediction of such failures, especially in complex systems, can enable the performance of preventative maintenance in a timely manner, and in some cases can prevent unexpected and unplanned downtime.

In some examples, it is desirable to be able to predict the occurrence of a future system event such as a system failure, based only on the data associated with the system, e.g. sensor data collected in the field. Methodology 100, to be disclosed herein in more detail, enables such a prediction. In some cases, this can provide at least certain example advantages. By predicting event/failure probability for e.g. a given time of occurrence, based on the gathered data, maintenance activities can be done “on time” -neither too early, nor too late.

As one example, some airline companies waste large sums of money every year on “unexpected” failures, which take down their fleet availability. An airline will, in some examples, prefer planned downtime, where maintenance is performed at a scheduled time, rather than e.g. performing maintenance on an unexpected or emergency basis, e.g. when an alert is raised. Of course, a failure of a major system which causes a crash, accident or other dangerous situation, in some cases catastrophic, which occurs because the relevant maintenance was not performed on time, is also an undesirable situation.

In addition, the burden of “unnecessary” maintenance, that is maintenance performed “too early”, at a point in time when no failure is in fact near occurrence, also weighs negatively, from a financial standpoint, for the system’s owner or user.

A brief summary of the data flow 100 of FIG. 1 is now disclosed, followed by step-by-step-details.

The presently disclosed subject matter discloses methods of training machine learning (ML) models to enable prediction 180 of occurrence of one or more events 250 (e.g. system failures) to be predicted, where the event(s) to be predicted is (are) associated with a system which is being analyzed. Such methods, and also related computerized systems and software products, are in some cases configured to perform at least the following:
i. provide or receive one or more trained Machine Learning (or other Artificial Intelligence-based) Anomaly Detection Models 120;
j. provide or receive one or more engineering analysis Tools 140, e.g. Analysis Tools 140;
k. receive first unlabeled data 110, which is associated with the system being analyzed;
1. input the first unlabeled data 110 to the one or more trained Machine Learning Anomaly Detection Models 120;
m. generate and output 133, using the one or more trained Machine Learning Anomaly Detection Models 120, indications 425 of occurrence of one or more input events 260, based on the first unlabeled data 110;
n. input 135 the indications 425 of the occurrence of the input event(s) 260 into the RAMS Analysis Tool(s) 140;
o. generate, using the RAMS Analysis Tool(s), quantitative indications 144 of the event(s) 250 to be predicted, based at least on the input 135 indications 425 of the occurrence of the input event(s) 260; and
p. generate, using the quantitative indications 144 of the event(s) 250 to be predicted, labels 146 for the first unlabeled data 110, thereby deriving first labeled data 115 from the first unlabeled data 110.

As indicated above, additional details of the above method are disclosed further herein.

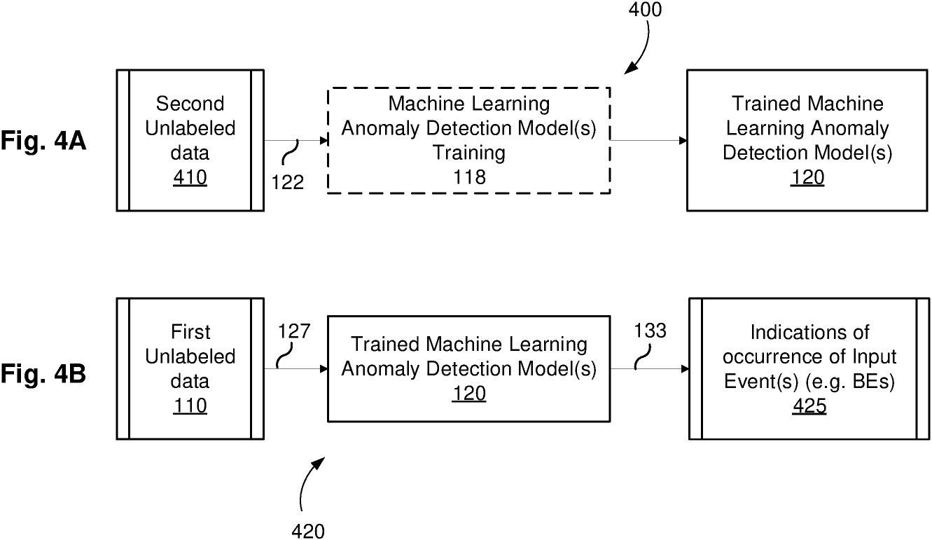

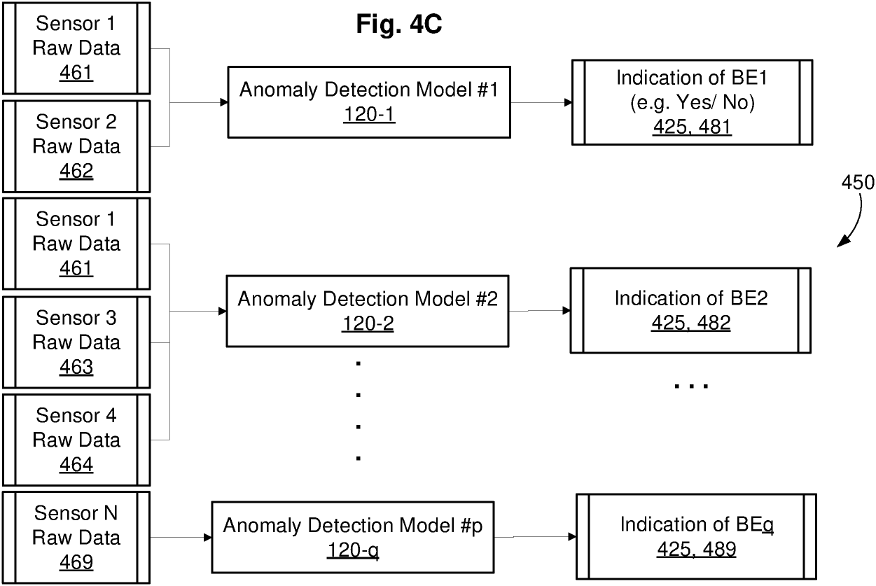

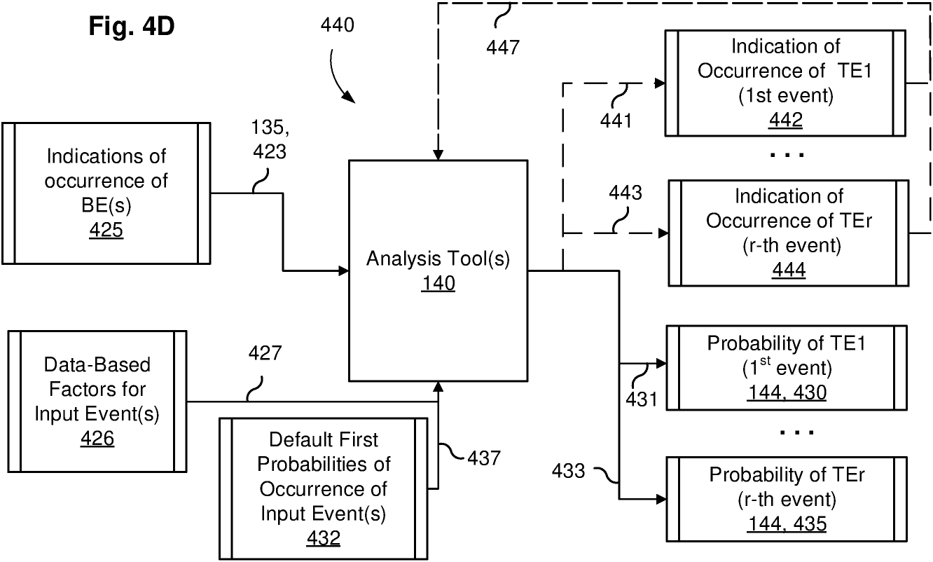

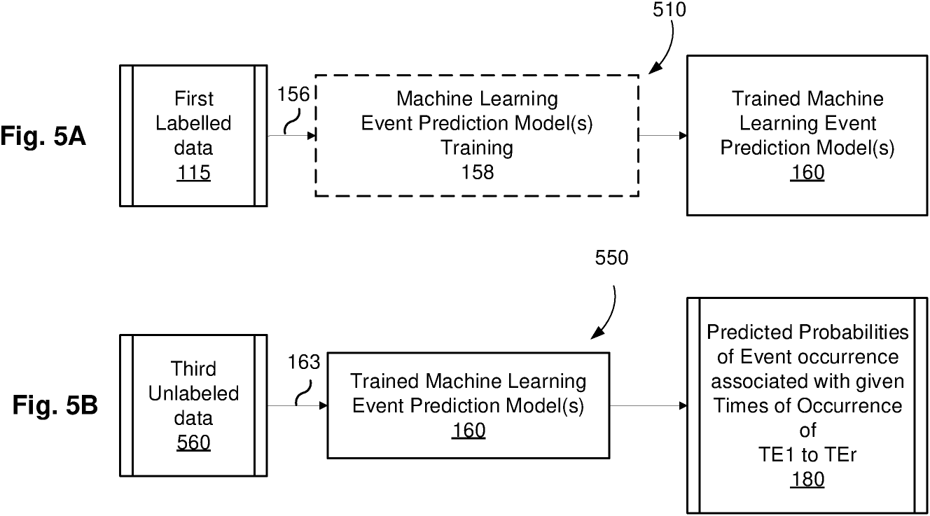

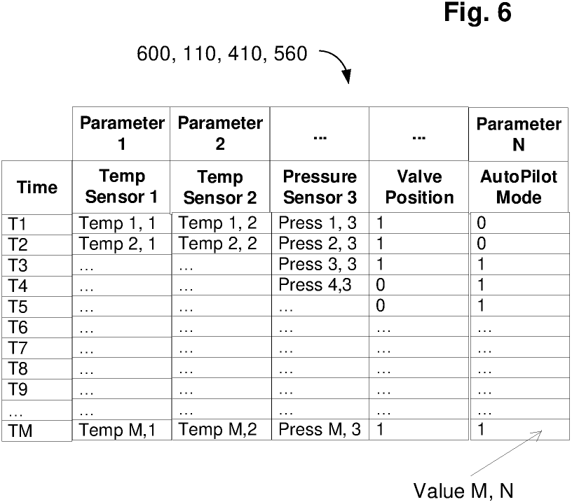

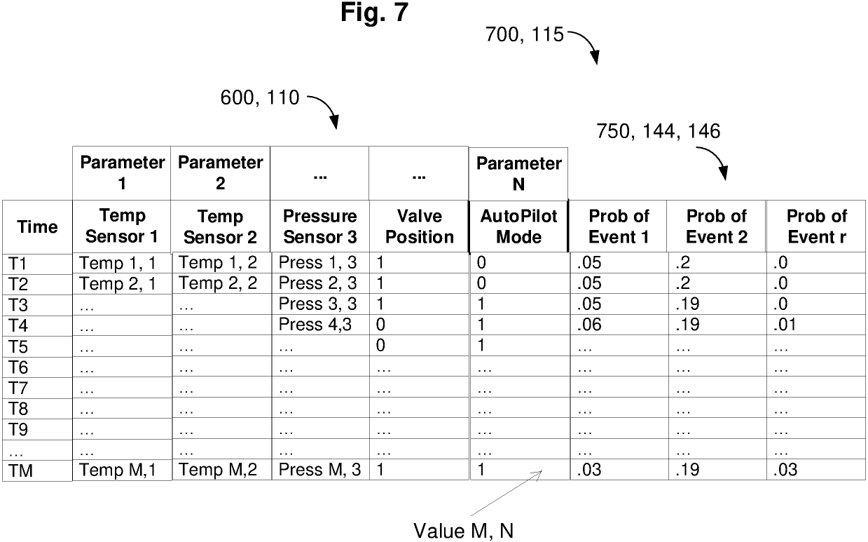

Note that data 110, as well as data 410, 560 disclosed further herein with reference to FIGS. 4A, 5B, are referred to herein also as unlabeled data, to distinguish them from labeled data such as 115. Note that the labels 146 of data 115 are based on the quantitative indications 144 of the event(s) 250 to be predicted. In some examples, the unlabeled data 110, 410, 560 include at least sensor data associated with one or more sensors associated with the system, e.g. as disclosed above. FIGS. 6 and 7, disclosed further herein, provide examples of unlabeled and labeled data.

In some examples, the first labeled data 115 is usable as a training database, to enable training 158 of one or more Machine Learning (or other Artificial Intelligence-based) Event Prediction Models 160 associated with the system. In some examples the trained Machine Learning Event Prediction Model(s) 160 are configured to predict, based on unlabeled data 163, predicted third probabilities 180 of occurrence of the event(s) 250 to be predicted. Non-limiting examples of such predicted events include engine failure or wing failure. In some examples, each predicted third probability 180 is associated with a given time of the occurrence of that predicted event.

The unlabeled data 163 are referred to herein also as third unlabeled data 163, to distinguish them from other unlabeled data disclosed further herein. The probabilities 180 of occurrence of the event(s) 250 to be predicted are referred to herein also as third probabilities, to distinguish them from other probabilities disclosed further herein.

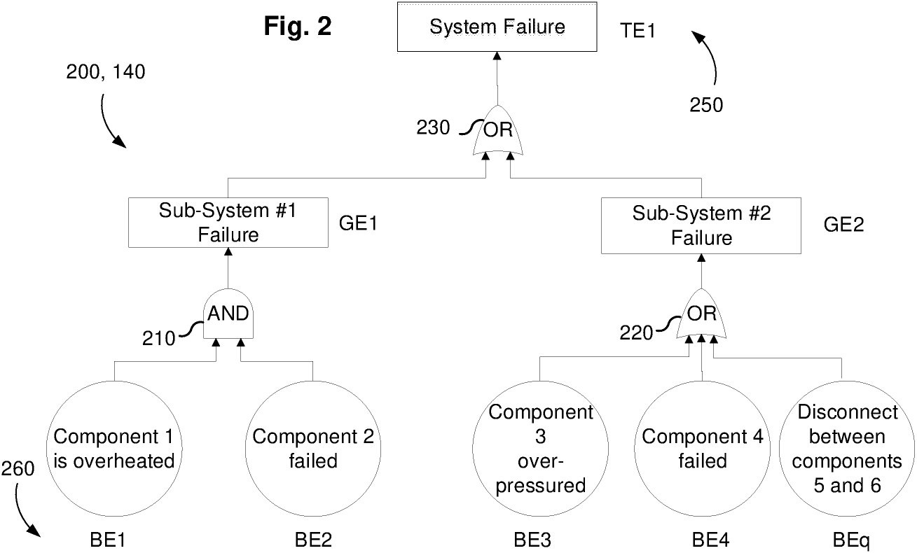

One non-limiting example of Analysis Tools 140 is Reliability, Availability, Maintainability and Safety (RAMS) Analysis Tools 140. In some examples, the Analysis Tool(s) 140 is configured to provide quantitative indications 144 (e.g. probabilities, referred to herein also as second probabilities) of the event(s) 250 to be predicted. In some examples, each event 250 to be predicted is associated with one or more input events 260. In some examples, the quantitative indications 144 of the event(s) to be predicted are based on the input events(s) 260. More detail on this is disclosed further herein with reference to FIG. 2.

The presently disclosed subject matter also discloses methods, and related computerized systems and software products, that are in some cases configured to train 158 the Machine Learning Event Prediction Model(s) 160 associated with the system, utilizing the first labeled data 115, thereby generating the trained Machine Event Failure Prediction Model(s) 160.

The presently disclosed subject matter also discloses methods, and related computerized systems and software products, that are in some cases configured to perform at least the following:
D. input the third unlabeled data 163 into trained Machine Learning Event Prediction Model(s) 160;
E. generate, using the trained Machine Learning Event Prediction Model(s) 160, the predicted probabilities 180 of the occurrences of the predicted event(s) in the system, based on third unlabeled data 163; and
F. output the predicted probabilities 180.

In some non-limiting examples, Machine Learning Event Prediction Model(s) 160 comprises a Bayesian Network or Deep Neural Network. As indicated above, additional details also of the above methods are disclosed further herein.

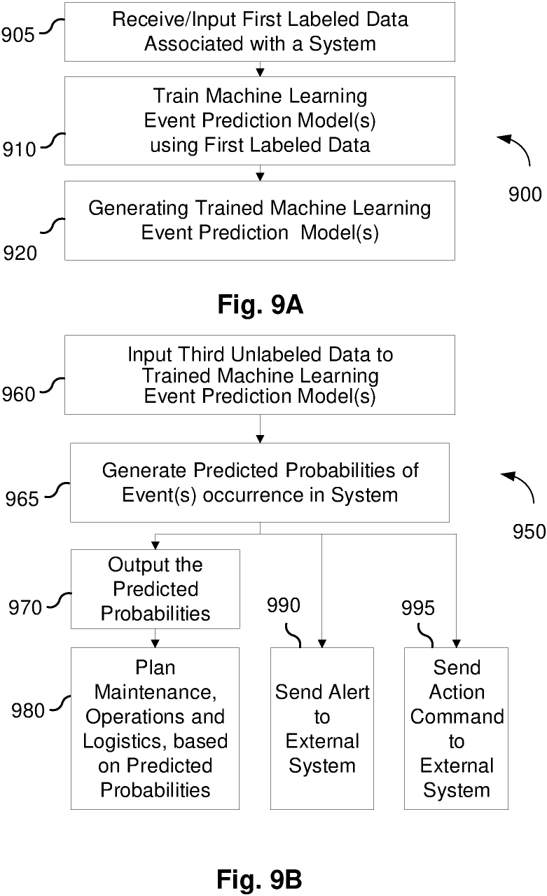

As will be disclosed further herein, an example advantage of the presently disclosed subject matter is as follows: the example methodology 100 enables generation of labels 146 for system-associated data 110 that did not have such labels 146. This in some examples enables training 158 of event prediction model(s) 160. Models 160 can generate predictions of future event such as e.g. failures, predicting the future condition of a particular system, which is in turn useful for e.g. Predictive Maintenance of the system. The methodology 100 thus in some cases enables prognostics of the analyzed events. Without such labels, in some cases it is not possible to train model(s) 160 based only on raw data such as 110, e.g. sensor data. Operational orders for e.g. maintenance activities, can, in such a case, be provided directly, based on collected data. Use of a model such as 160 enables, in some examples, performance of maintenance only when it is warranted, referred to herein also as condition-based maintenance, rather than doing routine maintenance performed in accordance with a fixed schedule. In this sense, such maintenance can be considered as adapted care, adapted for the specific predicted need, rather than on a pre-defined schedule that is not adapted for the specific instance of the system. Additional non-limiting examples of use of predictions of events for decision-making support include optimization of operations and optimization of logistics, as disclosed further herein with reference to FIG. 9B.

An additional example advantage is that labels 146 are generated, in some examples of the presently disclosed subject matter, by a combination of Artificial Intelligence techniques (e.g. Machine Learning) together with RAMS analyses that are based on engineering expertise. In example methodology 100, a machine learning model 120, for anomaly detection in the unlabeled data 110, is combined with RAMS Analysis Tool(s) 140 (e.g. Fault Tree Analysis, disclosed with reference to FIG. 2). The resulting labels 144 are then used to train 158 machine learning model 160, which itself received unlabeled data 163 as an input. As will be disclosed further herein, in some examples such a combination can provide quantitative indications 144 of the event(s) 250 to be predicted, e.g. to be used as labels 146 for first labelled data 115. Note that in some examples alternate labels, that are based on actual recorded histories of system events/failures, and that are associated with each data timestamp Ti, are not available, or are complex to obtain and derive. A methodology 100 such as disclosed herein can provide labels 146 in such cases. In addition, the labels 146 per methodology 100 are probabilistic labels, while those based on recorded event histories indicates occurrence or non-occurrence for each Ti, without probabilities. This additional probabilistic information per Ti can in some examples provide the ability to train 158 a prediction model 160 which is configured for predicting probabilities. Thus, in some examples several data-driven techniques are combined with tools of engineering field knowledge, to enable the required event(s) prediction 180.

In some examples, the quantitative indications 144 of the event(s) 250 to be predicted are usable as a diagnostic tool for the first unlabeled data 110. This provides an additional advantage of the presently disclosed subject matter, disclosed further herein.

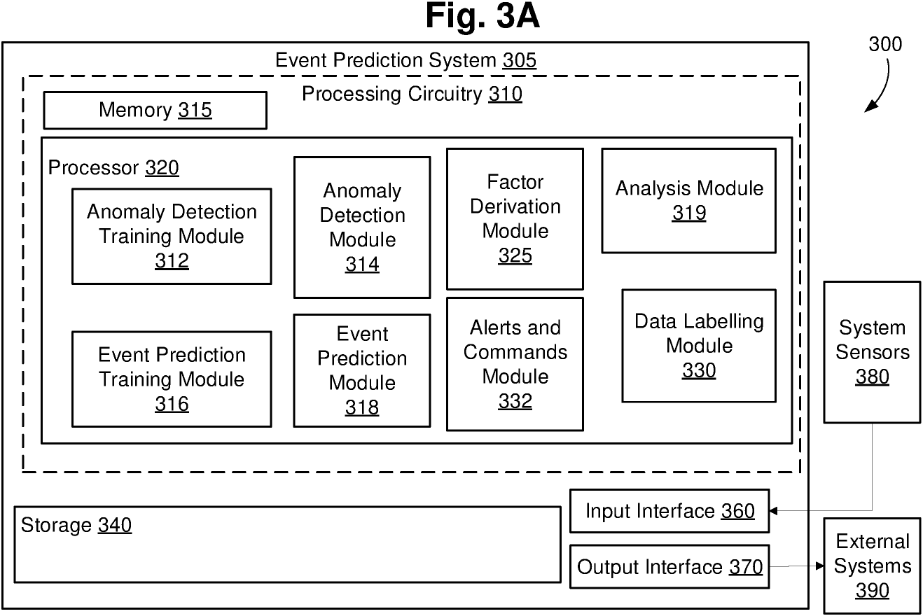

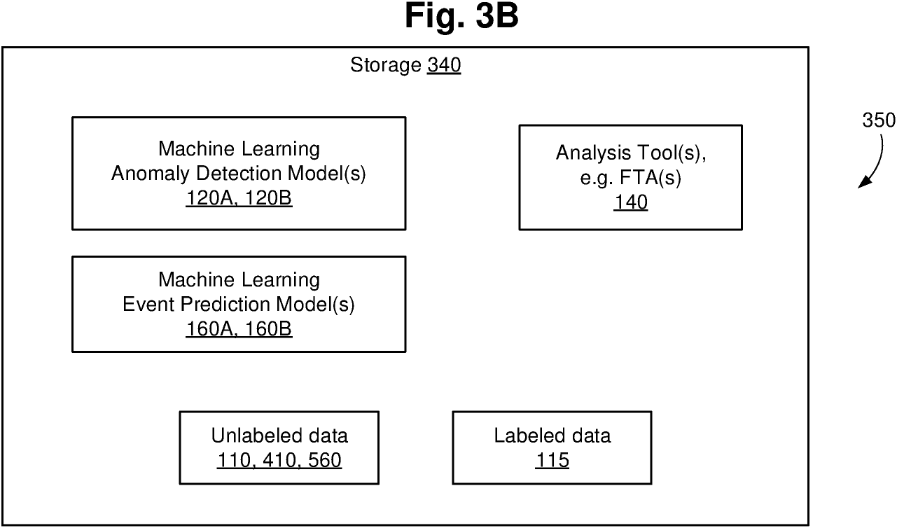

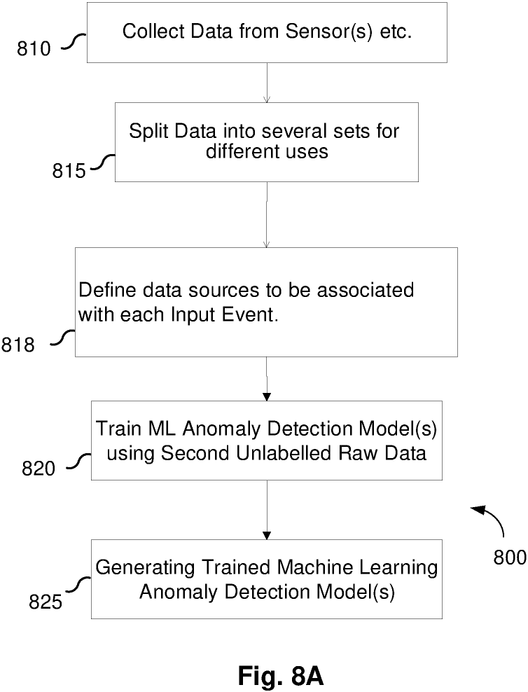

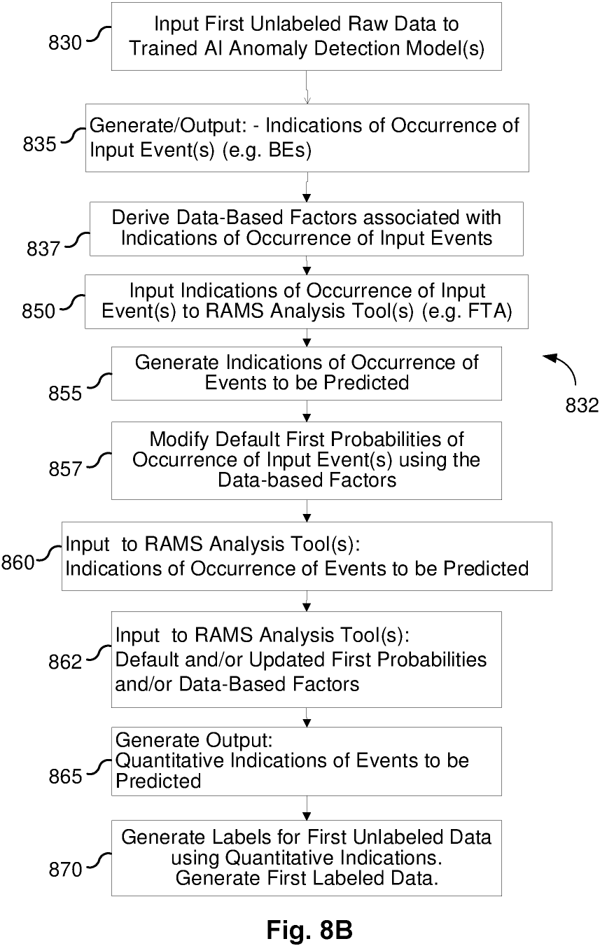

FIG. 1 presents the overall process and data flow 100 of the example methodology 100. FIGS. 4-5 provide more detailed flows of each stage of methodology 100. FIGS. 3 disclose a typical system architecture for implementing the methodology. FIGS. 8 disclose example process flows for the methodology. FIGS. 6 and 7 disclose examples of unlabeled data 110, 410, 560 and of labeled data 115, respectively.

Reverting to FIG. 1, unlabeled data 410, associated with the system to be investigated, is input 122, as a training set, to one or more Machine Learning (ML) Anomaly Detection Models 120. In some examples, data 410 is referred to herein also as second unlabeled data 410, to distinguish it from first unlabeled data 110. Models(s) 120 are trained 118 utilizing data 410. In some examples, this training is unsupervised, because data 410 has no labels, and thus data 410 may represent merely raw data, such as sensor data, that was collected in the field. The training process results in the generation of trained Machine Learning Anomaly Detection Model(s) 120. A more detailed example of this process is disclosed further herein with reference to FIGS. 4A, 8A.

Note that in FIGS. 1 and 3, the dashed-and-dotted lines indicate input to a training process, and the heavy solid lines indicate the generation of a trained model by a training process. The lighter solid lines indicate the input and output of a trained model.

First unlabeled data 110 associated with the system is input 127 to the trained Machine Learning Anomaly Detection Model(s) 120. Using the Model(s) Machine Learning Anomaly Detection Model(s), indications 425 of occurrence of one or more events 260, which are associated with components of the system to be analyzed, are generated and are output 133, based on the first unlabeled data 110. These events are referred to herein also as input events 260. These indications are associated with detections of possible anomalies in the first unlabeled data 110. In one example, where the Analysis Tool(s) 140 is a Fault Tree Analysis tool, these input events 260 are referred to as Basic Events (BE). More details regarding indications 425 of occurrence of input events 260 are disclosed further herein with reference to FIG. 2. More details regarding indications 425 of the occurrence of the input event(s) 260, and more detailed examples of the indication generation 133 process, are disclosed further herein with reference to FIGS. 4B, 4D and 8B.

The indications 425 of occurrence of input events are then input 135 to the one or more Analysis Tools 140, e.g. RAMS Analysis Tools. Analysis Tools 140 make use of Engineering knowledge, insight and understanding of system behavior, and of relations between system components and sub-systems. One non-limiting example of such a tool 140, that of Fault Tree Analysis 140, is disclosed in more detail further herein with reference to FIG. 2.

Using the Analysis Tool(s) 140, quantitative indications 144 of the system event(s) 250 to be predicted (e.g. a landing gear failure), are generated. One non-limiting example of such quantitative indications are second probabilities 144 of the event(s) to be predicted. This generation is based at least on the indications 425 of the occurrence of the one or more input events. In the non-limiting example tool of Failure Tree Analysis 140, the event(s) 250 to be predicted are referred to as Top Events, as disclosed further herein with reference to FIG. 2. More details on events to be predicted, about their relation to the input events, and about quantitative indications/ probabilities 144 of the system events 250 to be predicted, is disclosed in more detail further herein with reference to FIG. 2. As one non-limiting example, from the aerospace field, it may be that for the first unlabeled data 110 associated with T1, the probability 144 of engine failure is 0.05 or 5%, and the probability 144 of landing gear failure is 0.2 or 20%. A more detailed example of this process is disclosed further herein with reference to FIGS. 4D, 8B.

In some examples, Analysis Tool(s) 140 include default probabilities of occurrence of the input events. In such cases, determination of the quantitative indications/probabilities 144 of the events 250 to be predicted can be based at least on these default probabilities of occurrence. In some examples, the default probabilities 432 of the input events are referred to herein also as first default probabilities 432, to distinguish them from other probabilities. More details on these default probabilities are disclosed further herein with reference to FIGS. 2 and 4D.

Labels 146 are generated 125, 146 for the first unlabeled data 110, using the quantitative indications 144 of the one or more events to be predicted. First labeled data 115 are thereby derived from the first unlabeled data 110. In some examples, the labels 146 are the quantitative indications 144. An example depiction of first labeled data 115 is disclosed further herein with reference to FIG. 7. Note that in FIGS. 1 and 3, the heavy dashed lines indicate input to a labelling process.

Note that in some examples, first labeled data 115 is associated with a timestamp, e.g. a time of collection/recording/acquisition, similar to first unlabeled data 110. Note also that in some examples, the first labeled data 115 comprises condition parameters data, associated with characteristics of the system and/or characteristics of system operation.

First labeled data 115, associated with the analyzed system, is input 156 as a training set in order to train 158 one or more Machine Learning Event Prediction Models 160. Models(s) 160 are trained utilizing data 115. In some examples, this training is supervised. The training process results in the generation of trained Machine Learning Event Prediction Model(s) 160. One non-limiting example of Machine Learning Event Prediction Model(s) 160 is Machine Learning Failure Prediction Model(s) 160. A more detailed example of this process is disclosed further herein with reference to FIGS. 5A, 9A.

Unlabeled data 560 associated with the system is input 163 to the trained Machine Learning Event Prediction Model(s) 160. In some examples, data 560 is referred to herein also as third unlabeled data 560, to distinguish it from first and second unlabeled data 110, 410. The generated output 180 includes predicted probabilities 180 of occurrence of the event(s) 250 to be predicted. A more detailed example of this process is disclosed further herein with reference to FIGS. 5B, 9B. In some examples, the predicted third probabilities 180 are output for use by a user.

In some examples, the predicted probabilities 180 are referred to herein also as third probabilities, to distinguish them from e.g. other probabilities disclosed herein. In some examples, each third probability 180 is associated with a given time of the occurrence of the event.

Note that three sets of unlabeled data, 110, 410 and 560, are disclosed in the presently disclosed subject matter. In some examples, the first unlabeled data 110, the second unlabeled data 410 and the third unlabeled data 560 are distinct portions of a single data set. In one example, the user has collected a certain number of data records, and decides to use a first portion of the collected data for training 118 the Anomaly Detection Model(s) 120. The user decides to use a second portion of the collected data to run through the trained Anomaly Detection Model(s) 120, input the results of that run into RAMS Analysis Tool(s) 140, and use the resulting output to generate labels 146 for first unlabeled data 110. The user then uses the resulting first labeled data 115 to train 158 the Event Prediction Detection Model(s) 160. The user decides to use a third portion of the collected data for running through trained Event Prediction Detection Model(s) 160 to obtain and output predicted event probabilities 180.

In other examples, different sets of collected data are used for each set of unlabeled data. For example, data are gathered in January, and are used as second unlabeled data 410 to train 118 models 120. In February and March, additional data are gathered, and they are used as first unlabeled data 110 to derive first labeled data 115 and to train 158 the Event Prediction Detection Model(s) 160. In April through June, still more data are gathered, and they are used as third unlabeled data 560 to run through trained Event Prediction Detection Model(s) 160, thus obtaining and outputting predicted event probabilities 180.

Attention is now drawn to FIG. 2, schematically illustrating an example generalized view of a RAMS Analysis Tool 140, in accordance with some embodiments of the presently disclosed subject matter. RAMS Analysis Tool(s) 140 is referred to herein also as RAMS Analysis Techniques 140, or as hazard analysis techniques 140. RAMS Analysis Tool(s) 140 is disclosed herein as one non-limiting examples of an Analysis Tool(s) 140. Therefore, disclosure herein to RAMS Analysis Tool(s) 140 refers as well, in general, to Analysis Tool(s) 140. Event Tree Analysis 140 is another non-limiting example of an Analysis Tool(s) 140.

View 200 of the RAMS Analysis Tool 140 illustrates the non-limiting example of Fault Tree Analysis (FTA) tool 200, 140. RAMS Analysis Tool(s) 140 is an example of engineering analysis Tools 140. Fault Tree Analysis is a top-down, deductive failure analysis in which an undesired state of a system is analyzed using Boolean logic to combine a series of lower-level events. This analysis method is used, for example, in safety and reliability engineering, to understand how systems can fail, to identify the best ways to reduce risk and to determine event rates of a safety accident or of a particular system level failure (see Wikipedia ®).

Top Events (TEs) are non-limiting examples of events 250 to be predicted that are associated with a system. Examples of TEs include engine failure, communications system failure etc. They are the output (the top or uppermost/highest level) of the FTA. In the example, one Top Event, TE1, is shown. In general, each TE numbered “x” can be referenced by TEx. Events 250 are referred to herein also as predicted events 250.

The inputs to the tool (the bottom or lowest level) are the input events 260, which, in the case of FTA, are referred to as Basic Events (BEs). Such input events, referred to herein also as minimal events 260, are events or occurrences of physical phenomena associated with individual low-level components, events that cannot be broken down further into finer events, and that are thus basic. They are referred to herein as input events 260, since they are inputs to the Analysis Tool 140. In the example of the figure, a number “q” of events 260, labelled BE1 through BEq, are shown. Each BE numbered “x” can be referred to herein also as BEx.

Non-limiting examples of BEs for a Fault Tree Analysis 140 include:
low temperature
high pressure
sensor failure
cable disruption
great or high internal stress
presence of water
absence of water

In some examples, the BEs or other input events 260 are referred to herein also as first events, while the TEs or other events 250 to be predicted are referred to herein also as second events, to more clearly distinguish between them.

As shown in the figure, Boolean logic is used to combine series of lower-level events to determine the occurrence of higher-level events. For example, BE1 and BE2 are combined with a logic gate such as AND gate 210 to determine whether Sub-system #1 will fail. Sub-system #1 failure GE1 is an example of a Gate Event (GE), that is intermediate level events that link BEs to TEs. Note that in other examples, there can be multiple levels of GEs, rather than the one level shown in the figure. Note also that the gate event of sub-system #2 failure GE2 is derived from another Boolean combination, that is OR gate 220.

In some examples, the engineering staff responsible for specific systems and sub-systems create the FTA or other Analysis Tool 140, e.g. using known per se methods, based on their understanding of system components, of system architecture and function, and of possible failure modes and other component/sub-system/system events.

Note also that in other examples, not depicted in the figure, certain input events 260 can appear multiple times in the tool. For example, in some cases both GE1 and GE2 are dependent on BE2, and thus BE2 appears as an input event to each of those GEs.

A very simplified example of an FTA, with one TE and a small number of BEs and gates, is shown in FIG. 2, for illustrative purposes only. Real-life examples can have many more inputs 260 (BEs), levels, and outputs 250 (TEs). In some other examples, a separate RAMS Analysis Tool 140 (e.g. a separate FTA 200, 140) exists for each TE of interest, or for a sub-set of the TEs. Similarly, in some examples a tool 140 such as an FTA can be constructed for, and associated with, each module or sub-system (e.g. turbine blades) which together compose a highest-level, most-complex, system (e.g. an engine, or, in some cases, an entire aircraft). Similarly, two different TEs/events 260 can refer to two different events associated with a system, e.g. two different failure modes of an engine. In the case of FTA, there should be as many TEs in the FTA(s) as there are failure modes to predict.

Note that FIG. 2 illustrates a qualitative use of FTA 200, 140. In the examples of the figure, the FTA provides qualitative indications of TE1, referred to herein also as indications of occurrence of the one or more events 250, TE1 to be predicted. That is, the Boolean logic determines, for example, how failures in the system will occur -whether or not TE1 will occur, a Yes/No determination, e.g. with Boolean values 0 and 1. This may referred to herein also as a determination of “activation” of TE1, meaning whether or not that TE will occur and thus is “activated” in the analysis. The indications of occurrence of TEs and other events 250 are therefore referred to herein also as final activation results or final activation values.

Note that the Boolean logic can in some examples be represented as a Boolean mathematical function. For the example of the figure, the function can be:

$$\begin{matrix}\text{TE1 = GE1 OR GE2 =} \\ \left(\text{BE1 AND BE2}\right) \text{OR} \left(\text{BE3 OR BE4 OR} … \text{OR BEq}\right)\end{matrix} \qquad \text{(1)}$$

In some examples, the presently disclosed subject matter utilizes a quantitative exploitation of tool 140 - in addition to or instead of a qualitative exploitation. That is, the gates 210, 220, 230 are considered to represent mathematical combinations of quantitative indications, such as probabilities, of occurrence of events. As one non-limiting example, for the FTA 200 of the figure, the FTA can be represented as an occurrence probability function, providing quantitative information, e.g. probabilities of occurrence of the TEs/events 250 to be predicted.

For the example of the figure, and assuming that all BEs are independent events, the probabilities “P” can be derived with the following mathematical function, using e.g. per se known FTA methodologies:

Probability of occurrence of TE1:

$$\text{pTE1 =} \left(\text{pBE1 * pBE2}\right) + \text{pBE3 + pBE4 +} … \text{pBEq} \qquad \text{(2)}$$

In the presently disclosed, the notation pTEx and pBEx refer to the probability of occurrence of the TE and BE, respectively, that are numbered “x”.

Note that equation (2) represents a simple case, in which no BE appears twice, and where all the BEs are independent events. If this is not the case (e.g. where BE2 is an input event 260 to more than one gate), other, more complex formulas would be used. In the non-limiting example shown, probabilities are combined for the AND gate 210 using multiplication, and are combined for the OR gates 220, 230 using addition.

In some examples, default probabilities 432 of input events 260 such as BEs are known a priori, based on engineering estimates. For example, these component event probabilities can include component-manufacturer information and recommendations, for example component Mean Times Between Failures (MTBFs). In some examples, the default probabilities 432 of the input events 260 are referred to herein also as first default probabilities 432, to distinguish them from other probabilities disclosed herein. In some examples, default probabilities 432 are referred to herein also as elementary probabilities 432.

In some examples, the FTA or Analysis Tool 140 is provided with all of its necessary elements, including the probability functions for calculating pTEx 144 of each TE or other event 250 to be predicted, and the first default (a priori) BE/input event probabilities 432. Additional details on the use of default first probabilities 432 are disclosed further herein with reference to FIG. 4D.

Example implementations that combine performance of qualitative and quantitative analysis using Analysis Tool(s) 140 are disclosed further herein with reference to FIG. 4D. Note that in some case pTEx=0 for a particular TEx, e.g. if the qualitative analysis shows that its activation value is 0 (“No”).

FIGS. 4B, 4C and 4D disclose an example combination of engineering analysis tools 140 such as RAMS Analysis Tool(s) 140 with data-driven models such as model(s) 120. Machine learning algorithms and engineering expertise domains are used sequentially. In some examples, the results from a Fault Tree analysis or other Analysis Tool(s) 140 constitute the input or basis for training 158 a machine learning model(s) 160 configured for predicting event 250 occurrences. As will be seen below with reference to FIG. 5B, trained machine learning model(s) 160 is used to predict 180 events 250 based on input data 560 only -- without using in the prediction an analysis tool 140 such as FTA to analyze the data 560. However, the prediction model 160 is trained 158 based on data 115 which was labeled utilizing such analysis tools 140. Note also that the predictions 180 are performed in an automated fashion, by computerized event prediction system 305, without requiring a human engineer or operations person to perform an analysis and make a prediction of the occurrence of an event, for a given future time of occurrence.

The methodology 100 in such examples provides a process of decision making, starting from anomaly detection of data, linking the anomaly detection to features and system engineering, providing diagnostics 144 of the data, and then enabling the providing of prognostics and predictions 180 of events 250, so as to, for example, enable predictive maintenance steps and actions.

Note that Failure Tool Analysis 200, 140 is an example of an Event Tree Analysis 140, and of a RAMS Analysis Tool(s) 140. Additional non-limiting examples of such a tool 140 include Failure Mode and Effects Analysis (FMEA) and Failure Mode, Effects and Criticality Analysis (FMECA).

Attention is now drawn to FIG. 3A, schematically illustrating an example generalized schematic diagram 300 comprising a failure prediction system, in accordance with some embodiments of the presently disclosed subject matter.

In some examples, system 300 comprises an event prediction system 305. In some examples, system 305 is a failure prediction system 305. In some non-limiting examples, event prediction system 305 includes a computer. It may, by way of non-limiting example, comprise a processing circuitry 310. This processing circuitry may comprise a processor 320 and a memory 315. This processing circuitry 310 may be, in non-limiting examples, general-purpose computer(s) specially configured for the desired purpose by a computer program stored in a non-transitory computer-readable storage medium. They may be configured to execute several functional modules in accordance with computer-readable instructions. In other non-limiting examples, this processing circuitry 310 may be a computer(s) specially constructed for the desired purposes.

System 305 in some examples receives data for external systems. In the example of the figure, it receives sensor data which is recorded, logged, captured, collected or otherwise acquired by sensors 380. These sensors are comprised or otherwise associated with the system (e.g. a spacecraft engine) to be analyzed. This data is in some examples the unlabeled data 110, 410, 560 disclosed with reference to FIG. 1.

Processor 320 may comprise, in some examples, at least one or more functional modules. In some examples it may perform at least functions, such as those disclosed further herein with reference to FIGS. 4A through 9B.

In some examples, processor 320 comprises anomaly detection training module 312. In some examples, this module is configured to train 118 Machine Learning Anomaly Detection Model(s) 120, disclosed with reference to FIG. 1 as well as further herein. In the example of the figure, model(s) 160 is trained 118 using unlabeled data 410 as a training set. In some examples, Machine Learning Anomaly Detection Model(s) 120, and unlabeled data 410, are stored in storage 340.

In some examples, processor 320 comprises anomaly detection module 314. In some examples, this module is configured to receive, as an input, unlabeled data 110, to input them into trained Machine Learning Anomaly Detection Model(s) 120, and to output 133 indications 425 of occurrence of input event(s) 250.

In the example of the figure, trained model(s) 160 receives, as an input, unlabeled data 110.

In some examples, processor 320 comprises factor derivation module 325. In some examples, this module is configured to generate data-based factors 426. In some examples, these factors are generated based on the received indications 425 of occurrence of the BEs or other input events 260, and on the received first unlabeled data 110. The indications 425 of occurrence are generated and output by trained Anomaly Detection Model(s) 120. In some examples, these generated factors 426 are an input to Analysis Tool(s) 140. More details of data-based factors 426, their generation and their use, are disclosed further herein with reference to FIG. 4D.

In some examples, processor 320 comprises analysis module 319. In some examples, this module is configured to receive, as inputs, the outputs 133 of the Model(s) 120, e.g. indications 425 of input event 260 occurrence, as well as receiving the data-based factors 426 that were output by factor derivation module 325. In some examples, this module is configured to send these inputs to Analysis Tool(s) 140, so to receive outputs of quantitative indications 144 of events 250 to be predicted. In some examples, Analysis Tool(s) 140 is stored in storage 340.

In some examples, processor 320 comprises data labelling module 330. In some examples, this module is configured to generate labels 146 based on the received quantitative indications 144 of events 250 to be predicted (e.g. TEs) that are output from Analysis Tool(s) 140. The module also receives unlabeled data 110, and applies to them the labels 146, thereby deriving labeled data 115. In some cases, labelled data 115 is then stored in storage 340.

In some examples, processor 320 comprises event prediction training module 316. In some examples, this module is configured to train 158 Machine Learning Event Prediction Model(s) 160, disclosed with reference to FIG. 1 as well as further herein. In the example of the figure, model(s) 160 is trained 158 using labeled data 115 as an input 156 training set. In some examples, Machine Learning Event Prediction Model(s) 160, and labeled data 115, are stored in storage 340.

In some examples, processor 320 comprises event prediction module 318. In some examples, this module is configured to receive, as an input 163, third unlabeled data 560, to input them into trained Machine Learning Event Prediction Model(s) 160, and to generate predicted event probabilities 180 based on the third unlabeled data 560. In some examples, this output 180 is stored in memory 315.

In some examples, processor 320 comprises alerts and commands module 332. In some examples, this module is configured to alerts, and/or to send action commands, to external systems 390, as disclosed with reference to FIG. 9B.

In some examples, memory 315 of processing circuitry 310 is configured to store data associated with at least the calculation of various parameters disclosed above with reference to the modules, the models and the tools. For example, memory 315 can store indications 425 of input event 260 occurrence, quantitative indications 144 of events 250 to be predicted, and/or predicted event probabilities 180.

In some examples, event prediction system 305 comprises a database or other data storage 340. In some examples, storage 340 stores data that is relatively more persistent than the data stored in memory 315. Examples of data stored in storage 340 are disclosed further herein with reference to FIG. 3B.

In some examples, event prediction system 305 comprises input interfaces 360 and/or output interfaces 370. In some examples, 360 and 370 interface between the processor 320 and various systems and devices 380, 390 that are external to system 305. In some examples, event prediction system 305 includes dedicated modules (not shown) that interact with interfaces 360 and 370.

In some examples, system 300 comprises one or more external systems 390. In some examples, these external systems include output devices 390. Non-limiting examples of output devices 390 include computers, displays, printers, audio and/or visual devices etc., which can output various data for customer use. As one example, quantitative indications 144 of events 250 to be predicted, and/or predicted event probabilities 180, can be output to devices 390, for example in reports, to inform the customer about the various predicted probabilities of events.

In other examples, external systems 390 comprise systems that are located on or associated with the analyzed system, e.g. an airplane, and that display, or otherwise present, alerts to e.g. airplane personnel. In still other examples, external systems 390 comprise systems that are external to the analyzed system, e.g. a ground-based system, and that display or otherwise present alerts to e.g. control personnel using the ground-based system 390 in a control center. In still other examples, external systems 390 comprise systems that are located on or associated with the analyzed system, e.g. an airplane, and that receive action commands and perform actions based on those commands. Additional detail on such external systems 390 is disclosed further herein with reference to FIG. 9B.

Attention is now drawn to FIG. 3B, schematically illustrating an example generalized schematic diagram 350 of storage 340, in accordance with some embodiments of the presently disclosed subject matter.

In some examples, storage 340 comprises Machine Learning Anomaly Detection Model(s) 120, disclosed with reference to FIG. 1 as well as further herein. In some examples, model(s) 160 is trained 118 using unlabeled data 410. In some examples, trained model(s) 160 receives, as an input, unlabeled data 110.

In some examples, storage 340 comprises RAMS Analysis Tool(s) 140, e.g. a Failure Tree Analysis function or other tool 140, disclosed with reference to FIGS. 1 and 2, as well as further herein. In some examples, Analysis Tool(s) 140 receives, as inputs 135, the outputs 133 of the Model(s) 120, e.g. indications 425 of input event 260 occurrence, as well as receiving the data-based factors 426 that were output by factor derivation module 325.

In some examples, storage 340 comprises Machine Learning Event Prediction Model(s) 160. In some examples, model(s) 160 is trained 158 using labeled data 115 as an input 156. In some examples, trained model(s) 160 receives third unlabeled data 560 as an input 163. As disclosed with reference to FIG. 1, the trained model(s) 160 is configured to generate predicted event probabilities 180 based on third unlabeled data 163. In some examples, this output 180 is stored in memory 315.

In some examples, data store 340 can store unlabeled data 110, 410, 560 and/or labeled data 115.

The example of FIGS. 3 is non-limiting. In other examples, other divisions of data storage between storage 340 and memory 315 may exist.

FIGS. 3 illustrates only a general schematic of the system architecture, describing, by way of non-limiting example, certain aspects of the presently disclosed subject matter in an informative manner, merely for clarity of explanation. It will be understood that that the teachings of the presently disclosed subject matter are not bound by what is described with reference to FIGS. 3.

Only certain components are shown, as needed, to exemplify the presently disclosed subject matter. Other components and sub-components, not shown, may exist. Systems such as those described with respect to the non-limiting examples of FIGS. 3 may be capable of performing all, some, or part of the methods disclosed herein.

Each system component and module in FIGS. 3 can be made up of any combination of software, hardware and/or firmware, as relevant, executed on a suitable device or devices, which perform the functions as defined and explained herein. The hardware can be digital and/or analog. Equivalent and/or modified functionality, as described with respect to each system component and module, can be consolidated or divided in another manner. Thus, in some embodiments of the presently disclosed subject matter, the system may include fewer, more, modified and/or different components, modules and functions than those shown in FIG. 3s. To provide one non-limiting example of this, in some examples input and output interfaces 360, 370 are combined. Similarly, in some examples, there may be separate input interfaces 360 for each type of sensor (e.g. temperature vs pressure sensors). Similarly, in some examples processor 320 includes interface modules that interact with interfaces 360, 370. Similarly, in some examples database/data store 340 is located external to system 305.

One or more of these components and modules can be centralized in one location, or dispersed and distributed over more than one location, as is relevant. In some examples, the Event Prediction System 305 utilizes a cloud implementation, e.g. implemented in a private or public cloud.

Each component in FIGS. 3 may represent a plurality of the particular component, possibly in a distributed architecture, which are adapted to independently and/or cooperatively operate to process various data and electrical inputs, and for enabling operations related to data anomaly detection and event prediction. In some cases, multiple instances of a component may be utilized for reasons of performance, redundancy and/or availability. Similarly, in some cases, multiple instances of a component may be utilized for reasons of functionality or application. For example, different portions of the particular functionality may be placed in different instances of the component.

Communication between the various components of the systems of FIGS. 3, in cases where they are not located entirely in one location or in one physical component, can be realized by any signaling system or communication components, modules, protocols, software languages and drive signals, and can be wired and/or wireless, as appropriate. The same applies to interfaces such as 360, 370.

In the presently disclosed subject matter, a reference to a single machine learning model 120, 160 or analysis tool 140 should be construed to apply as well to multiple models and/or tools. Similarly, a reference to multiple models and/or tools should be construed to apply as well to a case where there is only a single instance of each model and/or tool.

Attention is now drawn to FIG. 4A, schematically illustrating an example generalized data flow 400 for models training, in accordance with some embodiments of the presently disclosed subject matter. The figure provides a more detailed example of the process of training model(s) 120, disclosed with reference to FIG. 1. Second unlabeled data 410 associated with the system to be analyzed is input 122 as a training set, in order to train 118 one or more Machine Learning (ML) Anomaly Detection Models 120. Models(s) 120 are trained utilizing data 410. In some examples, this training is unsupervised. The training process results in the generation of trained Machine Learning Anomaly Detection Model(s) 120. More details on the structure of Anomaly Detection Model(s) 120 are disclosed further herein with reference to FIG. 4C. A related process flow is disclosed further herein with reference to FIG. 8A.

Attention is now drawn to FIG. 4B, schematically illustrating an example generalized data flow 420 for utilizing Machine Learning Anomaly Detection Models 120, in accordance with some embodiments of the presently disclosed subject matter. The figure provides a more detailed example of the process of utilizing trained Anomaly Detection Model(s) 120, disclosed with reference to FIG. 1. First unlabeled data 110 associated with the system to be analyzed is input 127 to the one or more trained Machine Learning Anomaly Detection Models 120. Using the trained Machine Learning Anomaly Detection Model(s) 120, indications 425 of occurrence of the one or more input events 260 are generated 133, based on the first unlabeled data 110.

In some examples, these indications 425 of occurrence of the input event(s) 425 comprise Boolean values, for example indicating by Yes/No whether or not the particular input event (e.g. BE1) is expected to occur. In such a case, a result 425 of BE1=1, for example, can indicate that, based on the model 120, BE1 is expected to occur, while a result 425 of BE1=0 can indicate that, based on the model 120, BE1 is expected to not occur. In some examples, these indications 425 are referred to herein also as qualitative indications 425 of occurrence of the input events. In some examples these indications 425 are referred to herein also as activation results, activation indications, activation values or activation thresholds 425, since they determine whether or not to activate the particular BE/input event 260 (e.g. BE2) when traversing or otherwise being processed by the Analysis Tool(s) 140.

Note that in some examples the model determines whether it detects an anomaly in the first unlabeled data 110. Based on determination of possible data anomalies, the model in some examples sets the indication of occurrence of a particular input event (e.g. BE3) to 1= Yes. Thus, the indications 425 of the occurrence of the input events 260 are associated with indications of anomalies in the first unlabeled data 110. Anomalies in certain combinations of the data indicate a possibility or likelihood of an input event 260 occurring.

Note that, in the example of the figure, the model 120 is taking a purely mathematical and data-driven analysis of the unlabeled data 110 (a Yes or No regarding occurrence of an input event). This mathematical analysis indicates whether or not a particular set of data 110 seems anomalous mathematically, compared to “usual” values of this data as learned during the training of FIG. 4A). The model 120 links this analysis to physical characteristics of the system, e.g. to an actual physical event 260 or occurrence of a physical phenomenon 260 related to system components (e.g. a particular cable is disconnected, a particular physical component is at high temperature, water is present in a particular physical component). Thus FIG. 4B links mathematical and data-driven information, e.g. based on Big Data, to physical events. Without actually knowing physical characteristics of the system, based on detection of data anomalies, physical events in the system are determined to have a probability of occurring, via at least the indications 425 of occurrence of each input event 260.

As will be disclosed further herein with reference to FIG. 4D, in some examples another mathematical result derived by processor 320, which is related to the output of anomaly detection model(s) 120, are data-based numeric factors or ratios 426, which are indicative of probabilities of a particular BEx or other input event 260 occurring. These data-based factors 426 are referred to herein also as quantitative indications of occurrence of the input events 260.

Attention is now drawn to FIG. 4C, schematically illustrating an example generalized data flow 420 for utilizing Machine Learning Anomaly Detection Models 120, in accordance with some embodiments of the presently disclosed subject matter. The figure provides a more detailed example of the process of utilizing trained Anomaly Detection Models Model(s) 120, which was disclosed with reference to FIG. 4B, by showing a breakdown of the models 120. In the figure, a number “q” of separate ML Anomaly Detection Models 120-1 through 120-q have been defined for a particular system being analyzed (e.g. an engine). In the example, each such model is configured to generate indications 425 of occurrence of a different input event 260. That is, each input event 260 (e.g. each BEx) is associated with a Machine Learning Anomaly Detection Model 120-x. In the example of the figure, these input events are Basic Events BE1 through BEq, and the indications 425 of occurrence of each are numbered 481, 482 and 489.

As disclosed above with reference to FIG. 4B, each model 120-x connects the relevant BEx to a particular sub-set of the unlabeled data 410, 110, e.g. data associated with or received from specific data sources. In the non-limiting example of the figure, the unlabeled data are all raw sensor data, collected and received from a number “N” of sensors. FIG. 4C discloses several non-limiting example possibilities of the relationship between the unlabeled data and the input events 425. For example, BEq is associated with only one sensor, sensor N 469, while BE1 is associated with, or mapped to, two sensors (Sensor 1 461 and Sensor 2 462), and BE2 is associated with three sensors. Note also that certain data sources can, in some cases, be associated with multiple anomaly detection models, and thus with more than one input event 260. For example, in the figure Sensor 1 461 is associated with both BE1 and BE2.

Second unlabeled data 410 from the relevant data sources (e.g. from the relevant sensors) will thus be used 122 to train each Anomaly Detection Model 120-x. Unlabeled data 110 from the relevant data sources will thus be input 122 to each Anomaly Detection Model Anomaly Detection Model 120-x, to generate the relevant indications 481, 482, 489 of the BEs or other input events 260.

In some examples, the definition of each ML Anomaly Detection Models 120-x is performed by engineering staff, who define an association between each BE or other input events 260 and a subset of the data sources such as 461, 462 etc.. In some examples, such an association will enable the correct inputs (training data sets) to train each corresponding anomaly detection model 120-x, which outputs each indication 481, 482, 489 etc. of the corresponding BEs or other input events 260. That is, the correct training set for each anomaly detection model 120-x is determined. In some examples, these choices are based on engineering knowledge. In some cases, this engineering knowledge and insights are reflected in, and represented by, the FTA 140 or other Analysis Tool(s) 140 which the engineer constructed. In creating the FTA 140 or other Analysis Tool(s) 140, the complex system to be analyzed is decomposed and modularized, e.g. according to requirements and physical boundaries among sub-systems. In some examples, such a method building of the models provides more robust and accurate models.

In some non-limiting example cases, the machine learning model 120-x is an anomaly detection algorithm such as, for example, One Class Classification Support Vector Machine (OCC SVM), Local Outlier Factor (LOF), or One Class Classification Random Forest (OCC RF).

Note that a data anomaly does not in all cases indicate a particular event such as a failure. In some examples, anomaly data indicates a trend in the data, that points to a possibility of occurrence of the input event 260 at a future time.

In some examples, there is an input event such as BE1 generated for each timestamp. For example, there may be a record BE1-1 associated with sensor measurements 461, 462 that were recorded at time T1, a record BE1-2 associated with sensor measurements 461, 462 recorded at time T2, and so on. In some other examples, a single input event record such as indication of occurrence BE1-1 is associated with a plurality of timestamps s, e.g. with a cluster of timestamps, for example associated with sensor measurements recorded at times T1 through T6. In this example, the six sensor measurements for temperature (for example), for six consecutive measurement times, together indicate only one anomaly in temperature. The single anomaly presented itself over a period of time. As one example, the engineer may know a very high temperature occurring for a period of 6 seconds is not anomalous, but that such a temperature continuing for 30 seconds is anomalous, and is possibly problematic.

In some such examples, also a single quantitative indication 144 of the event(s) 250 to be predicted, which is generated by Analysis Tool 140, is associated with the plurality of timestamps. An example reason for such a phenomenon is that the model is unable to determine based on one record, e.g. only that of time T1, whether certain data is anomalous, and it requires a larger set of records (e.g. data required during consecutive times T1 to T6) to make such a determination of data anomaly.

Attention is now drawn to FIG. 4D, schematically illustrating an example generalized data flow 440 for utilizing Analysis Tool(s) 140, in accordance with some embodiments of the presently disclosed subject matter. The figure provides a more detailed example of the data flow 440 for the process of utilizing tools 140, disclosed with reference to FIG. 1. The example of the figure shows RAMS Analysis Tool(s) 140, e.g. FTA(s) 140. Note that, for ease of exposition, one tool 140 is shown which outputs results for each event 250 to be predicted. In other examples, there can be several Tools 140, each determining output for a sub-set of the TEs/event to be predicted 250, or even for one TE, as discussed above with reference to FIG. 2.

In some examples, indications 425 of occurrence of input event(s) 260 (e.g. of BEs), which are output 133 by Anomaly Detection Model(s) 120-x, are input 135, 423 into Analysis Tool(s) 140. Utilizing the Analysis Tool(s) 140, quantitative indications 144, 430, 435 of the predicted event(s) 250 are generated, based at least on the indications 425 of the occurrence of input event(s) 260. As disclosed above with reference to FIG. 1, in some examples these quantitative indications 144 are probabilistic indications, e.g. probabilities 144 of occurrence of the event(s) 250 to be predicted. In some examples, these are referred to also as second probabilities 144, to distinguish them from e.g. the first default probabilities 432.

In the non-limiting example of the figure, the events 250 to be predicted are FTA Top Events, and a probability pTEx is generated 431, 433 for each of the number “r” of events 250 to be predicted. Probability pTE1 of the first such event is designated by reference 430, while pTEr of the r-th event is designated by 435.

Such a determination utilizes, in some cases, the quantitative representation of Tool(s) 140, e.g. functions or equations such as equation (2). Note that in some cases, the quantitative indication of a particular TE or other event 250 can have zero value, e.g. pTEx =0.

In some examples, the determination of the probabilities of events 250 to be predicted is dependent on those of the input events 260, as disclosed above with reference to FIG. 2. Default first probabilities 432 of the occurrence of the input events 260 are in some examples comprised within the Analysis Tool(s) 140, again as disclosed with reference to FIG. 2, and are utilized in the determination or calculation of the predicted event 250 probabilities 430, 435. In some examples, the default first probabilities 432 of occurrence of input events/BEs 260 are input 437 into the Analysis Tool(s) 140, to enable their incorporation and/or utilization in the tool.

In some examples of this implementation, an additional input into Tool(s) 140 are data-based factors 426 for input event(s) 260. More on factors 426 is disclosed further herein.

In one such example implementation, for those BEs 260 which have an indication 425, 481, 482, 489 of occurrence having the value “no”, “not activated”, or “0”, the corresponding input probability pBEx is set to 0, rather than using the corresponding default first probability 432 for that BEx. For BEs 260 with indication 425 having the value Yes or 1, the corresponding default first probability 432 is used.

In a second example implementation, the Analysis Tool(s) 140 is traversed twice. The first traversal is a qualitative, logical or Boolean one, where the Tool 140 is traversed using the Boolean gates 210, 220, 230 or functions/equations such as equation (1). The RAMS Analysis Tool(s) 140 is, in this implementation, configured to also provide qualitative indications of the event(s) 250 to be predicted.

The inputs to this first traversal are only the indications 425 of the occurrence of the BEs, e.g. Boolean values per BE. Using the one or more RAMS Analysis Tool(s) 140, indications 442, 444 of occurrence of the event(s) 250 to be predicted are generated 441, 443.

In some examples, the r resulting output 441, 443 indications 442, 444 of the occurrence of the r TEs 250 are also logical Boolean values. For example, a result may be that the Indication of occurrence of TE1 equals 1 and the Indication of occurrence of TE2 equals 0. These indications 442, 444 of occurrence of the event(s) 250 to be predicted are examples of qualitative indications of the event(s) 250 to be predicted.

These logical results 442, 444 are, in this second example implementation, fed back 447 as an input to the Analysis Tool(s) 140. This feedback can be considered in some cases an internal loop of the Tools 140, and thus the indications 442, 444 of the occurrence of the “r” TEs 250 can be considered interim or intermediate results, which are internal to the process of Tools 140. In some examples, these indications 442, 444 of occurrence of a TE 250 are referred to herein also as final activation results or final activation values 442, 444, since they decide whether or not to activate the particular TE in the next stage of calculation.

Based on the feedback 447, a second traversal of Tools 140 is performed, a quantitative one, in which probabilities of e.g. TEs are calculated. In this second traversal, the quantitative determination utilizes, in some cases, the quantitative representation of Tool(s) 140, e.g. functions or equations such as equation (2).

In some examples, determination of probabilities 144, 430, 435 of events to be predicted 250 is performed only for those predicted events/TEx 250 having Indication of occurrence equal 1 or Yes from the first traversal. Probabilities 144, 430, 435 of those predicted events/TEx 250, which have indication of occurrence equal to 0 or No, are immediately set to pTEx = 0.0. Thus the indications of occurrence of TEs or other events to be predicted 260 can in some examples can directly provide labels 146 for first labeled data 110.

The inputs to this second traversal, in addition to the feedback information 447, are default first probability 432, e.g. comprised in Tool(s) 140, and in some examples also data-based factors 426 for input event(s) 260. More on factors 426 is disclosed further herein.

Based on these inputs, in the second traversal the Analysis Tool(s) 140 generates the quantitative indications 144, 430, 435 (e.g. probabilities pTEx) of the event(s) 250 to be predicted, only with respect to those events 250 to be predicted that are associated with positive qualitative indications 442, 444 of occurrence of that respective event. That is, as disclosed above, in some examples Tool 140 generates the quantitative indications 430, 435 only with respect to those events 250 to be predicted for which the indications 442 of occurrence are equal to 1 or Yes. For those TEs (for example) with indication 444 of occurrence = 0 or No, on the other hand, the corresponding pTEx is simply set to 0, without the need for the detailed calculation of e.g. equation (2).

As one simplified illustrative example of the above, assume that TE4 is derived by the logical expression BE5 AND BE6, and TE5 is derived by the logical expression BE8 AND BE9. Assume also that the default probability 432 of each of these BEs is 0.5. Assume also that the logical Boolean functions associated with Tool 140, plus the indication 425 of occurrence of input events 260, generate the following results: indication 442 of occurrence of TE4 is 0, while indication 442 of occurrence of TE5 is 1. In the second traversal of Tool 140, all of these values are input to the tool. The Tool 140 generates the result that pTE5 = 0.5 * 0.5 = 0.25, while pTE4 is set to 0, due to the fact that indication of occurrence of TE4=0.

As indicated above, in some examples, Analysis Tool 140 generates a probability 144, 430, 435, or other quantitative indication, of an event 250 to be predicted, such as TE1, generated for each timestamp. For example, there may be a record pTE1-1 associated with sensor measurements 461, 462 recorded at time T1, a record pTE1-2 associated with sensor measurements 461, 462 recorded at time T2, and so on. In some other examples, a single quantitative indication 144, 430, 435 of an event 250 such pTE1-1 is associated with a plurality of timestamps, e.g. with a cluster of timestamps, e.g. with sensor measurements of first unlabeled data 110 which were recorded at times T1 through T6.

Note that the quantitative indications 430, 435 of events 250 to be predicted are in some examples the final result and output 144 of Analysis Tool(s) 140. Note also that in some examples the final results 144 can be used for the labeling 146 process for labelled data 115. An example depiction of labeled data 115 is disclosed further herein with reference to FIG. 7. The various implementations of method 440 disclosed above assume that the only basis for determining the probabilities of input events 260 are the default first probabilities 432 of occurrence. In some other examples, data-based factors 426 associated with one or more of the input events 260 are also utilized. In some examples, these factors 426 are an additional input 427 into the Analysis Tool(s) 140. Such factors can be applied, in some examples, to one or more of the implementation methodologies disclosed herein with reference to method 440.

In some examples, after utilizing the trained ML anomaly Detection Model(s) 120 to generate 133 the indications 425 of occurrence of the input events 260, data-based factors 426 are generated. In some examples, factors 426 are generated based at least on the indications 425 of occurrence of the input events 260, and on the first unlabeled data 110. Each factor corresponds respectively to the indications of occurrence one of the input events 260. In some examples, this is performed based on engineering understanding of the systems, components and data sources, e.g. using known per se methods. In some examples, this engineering knowledge and insight is programmed or otherwise implemented in an algorithm, e.g. within factor derivation module 325.

In some examples, there may be a need for such factors 426, which operate on the default probabilities 432. For example, the anomaly detection model 120 may indicate that for time T35, the indication 425 of occurrence BE4 is equal to 1, i.e. the event is expected to happen and should be activated within the Tool(s) 140. However, the first labelled data 110 is such that there is some uncertainty whether in fact an anomaly in the data 110 exists, and thus there is an uncertainty associated with this indication of 1 at T35, and with the indication’s impact on pBE4. Thus the engineering algorithm comprised in factor derivation module 325 looks at considerations such as, for example, the frequency of the detected anomaly, the number of consecutive times of measurement that the particular anomaly appears, the duration of the anomaly, the density of the detected anomaly within a certain period of time, etc. If the uncertainty is high, that is if there is strong doubt whether there is an anomaly, a low value of factor 426, e.g. 0.05, may be assigned. This may occur, for example, when the anomaly in the data appears only occasionally, and not consistently. If the uncertainty is low, that is the data indicates that the data anomaly is quite certain, the factor 426 may have a relatively high value, e.g. 0.99.

In some examples, the factor 426 is a weight or ratio between 0 and 1. In some other examples, the factor 426 is a ratio that can be higher than 1, e.g. with a range of 0 to 50. In some examples, the data-based factor 426 is referred to herein also as an indication of probability of activation, as a ratio of activation, or as an activation ratio 426. In some examples, the determination of values of factors 426 associated with a particular input event 260 is based at least partly on a mathematical analysis of the indications 425 of occurrence of that corresponding input event 260, which are output 133 by the detection model 120. For example, if for BE1 the indication 425 of occurrence is equal to 1 for a certain number of consecutive timestamps, the certainty of the indication 425 corresponding to BE1 may be higher, and the factor 426 determined may be high. If, per an example, for BE3 the indications 425 of occurrence over seven times of measurement are 1, 0, 0, 0, 0, 1, 0, where the “1” value is relatively infrequent, the certainty of the “1” values may be low, and thus factor 426 is assigned a relatively low value. If, per another example, for BE3 the indications 425 of occurrence over seven times of measurement are 1, 0, 1, 0, 1, 0, 1, i.e. are constantly changing, this may be a strong indication of anomaly, the certainty of the “1” values may thus be high, and thus factor 426 is assigned a relatively high value.

Note that in some examples, where the model(s) 120 determine with great certainty that there is no anomaly in a particular set of data, the indication 425, 481 of occurrence of the input event 260 is set to 0, and thus no factor 426 is required.

The factors 426 are referred to herein as data-based factors 426, since in some examples they are derived based on an engineering analysis of the first unlabeled data 110 and/or of the indications 425 of BE 260 occurrence.

In one example implementation, the data-based factors 426 for each input event 260 are used to modify the probabilities of corresponding input event 260. In some examples, the default first probabilities 432, of occurrence of one or more of the input events 260, are modified, based on corresponding data-based factors 426. Modified first probabilities (not shown) of occurrence of the relevant input events 260 are thereby derived. In some examples, the updated first probability is referred to herein also as an updated first probability, or as a re-engineered first probability. In some examples, these updated first probabilities are input or otherwise utilized by analysis tool(s) 140.

For example, assume that the factor 426 corresponding to BE1 has the value 0.5, and that the default first probability 432 of BE1 is 0.6. By multiplying the two numbers, for example, a modified first probability of 0.3 = 0.5 * 0.6 is derived or generated. Assume that factor 426 corresponding to BE2 has the value 7, and that the default first probability 432 of BE2 is 0.1. An updated first probability of 0.7 = 7 * 0.1 is derived or generated. Note that for BE2, the factor in this example is greater than 1, and thus the probability of BE2 is amplified. This can occur, for example, when a probability of failure of a component has a certain manufacturer’s default, a relatively low number such as 0.1, but when the anomalies in the first unlabeled data 110 are such that there is a much higher certainty that, in the particular system being analyzed, this particular failure is very likely occurring.

Thus the probability pBEx of a particular input event 260 is in some examples a mathematical function of both the first default probability 426 of BEx and the factor 426, which in turn is derived for BEx based on the first unlabeled data 110 and the indicator 425, 481 of occurrence that was generated for BEx based on the anomaly detection model 120-x.

In some examples, the generation of data-based factors 426 by the factor derivation module 325 provides at least additional example advantages. In examples where the anomaly detection model(s) 120 are configured to provide only Yes/No logical indications 425 of occurrence of input events, the derivation of factors 426 adds a set of quantitative parameters that can each operate mathematically directly on the corresponding default first probabilities 432.

Note also that in some examples, data-based factors 426 are generated for certain input events 260, e.g. for BE2, but are not generated for certain other input events 260, e.g. for BE63.

In a similar manner, in some examples, if the qualitative/logical/Boolean indication 425, 481, of a particular BEx or other input event 260, is equal to No (=0), the corresponding probability pBEx will be set to 0 when traversing the Analysis Tool(s) 140, regardless of the first default probability 432 value of BEx. This reflects the fact that, in some examples, if the probability of an anomaly in certain data is 0, the probability of the input event 260 that corresponds (per anomaly detection model 120-x) to that data, is also 0.

In some examples, the quantitative indications 144, 430, 435 of the various TEs or other event(s) 250 to be predicted, generated by FTA or other Analysis Tool(s) 140, are usable as a diagnostic tool for the first unlabeled data 110. In some examples, this provides the example advantage of associating, with sets of first unlabeled data 110, an indication whether a particular failure mode or other event 250 is likely to occur, e.g. a diagnosis that the analyzed data indicates a situation will result in the event with a certain probability. Note that in some examples, pTEx=0, a zero probability. Attention is now drawn to FIG. 5A, schematically illustrating an example generalized data flow 510 for models training, in accordance with some embodiments of the presently disclosed subject matter. The figure provides a more detailed example of the process of training model(s) 160, disclosed with reference to FIG. 1. First labeled data 115, associated with the system to be analyzed, is received and input 156 to one or more Machine Learning (ML) Event Prediction Models 160. Models(s) 160 are trained utilizing data 115. In some examples, this training is supervised. The training process results in the generation of trained Machine Learning Event Prediction Models(s) 160. A related process flow is disclosed further herein with reference to FIG. 9A.

In some non-limiting examples, Machine Learning Prediction Model(s) 160 is a Bayesian network or a Deep Neural Network.

Note that the methodology 100 of the presently disclosed subject matter, in some examples, involves unsupervised training of one model or set of models, 120, and supervised training of the second model or set of models, 160. The second model(s) 160 is trained based on labels that are derived by utilizing a combination of the first model(s) 120 and an engineering analysis tool(s) 140. Based on an analysis of data 110 that indicates occurrence of component-level events 260, and use of engineering analysis tool(s) 140 that relates component-level events to system-level events 250, model 160 can be trained 158 to predict occurrence of the system-level events 250.

Note that in some examples two machine learning models are required to perform the methodology 100. The anomaly detection model 120 is required to detect anomalies in raw data such as first unlabeled data (e.g. sensor data) 110, where there is no indication per se of e.g. a Top Event failure. By deriving insights from this data, in the form of activated input events/ Basic Events 260, Top Events or other system-level events 250 can be related to the first unlabeled data 110. This relation in turn can serve to provide supervised training of event prediction model 160. Such a model 160 enables linking raw data 560 to predicted probabilities, associated with times of occurrence, of e.g. Top Events 250. This in turn can, in some examples, enable predictive maintenance activities.

Attention is now drawn to FIG. 5B, schematically illustrating an example generalized data flow 550 for utilizing Machine Learning Event Prediction Models 160, in accordance with some embodiments of the presently disclosed subject matter. The figure provides a more detailed example of the process of utilizing trained Event Prediction Model(s) 160, which was disclosed with reference to FIG. 1. In the example of the figure, third unlabeled data 560 is input 163 into the ML Event Prediction Model(s) 160. Utilizing the ML Event Prediction Model(s) 160, predicted third probabilities 180 of occurrence, of the event(s) 250 to be predicted, are generated, based on the third unlabeled data 560. In some examples, these third probabilities 180 are output, e.g. to output devices 390.

Note that in some examples the third unlabeled data is operational data 560 from e.g. a customer system. That is, in some cases, using first and labelled second data, the various models 120, 160 are trained 118, 15, and then operational data 560 from a customer can be used to perform the predictions 180. In some examples, the Event Prediction Model(s) 160 is used to predict the probability 180, and time, of occurrence of failure or other events 250.

In some examples, each third probability 180 is a is associated with a given time of occurrence of the event. As one example, the model(s) 160B can be configured to generate a predicted probability 180 of occurrence of a particular failure mode TE2, for each of 3 months from now, 6 months and 12 months from now. In some other examples, the predicted probability 180 is generated for minutes or hours from now.

Thus, in some examples, the actual state of the system is predicted based on the predictive model 160. The future state of the system is predicted as a function of time.

Note that Machine Learning Prediction Model(s) 160 is in some examples trained 158 (per FIG. 5A) using labelled data, i.e. data 115, and is used for event prediction with unlabeled data, i.e. data 560.

Attention is now drawn to FIG. 6, schematically illustrating a generalized view of an example of unlabeled data, in accordance with some embodiments of the presently disclosed subject matter. The figure provides a more detailed example 600 of unlabeled data 110, 410, 560.

Example data table 600 shows N parameters: Parameter 1 through Parameter N, some of them sensor data, collected or recorded at M points in time T1 through TM. Each data parameter instance is associated with the parameter number and with the timestamp. For example, Temp (1,2) is a temperature measured at time T1 and Parameter 2 = Temperature Sensor 2. Thus, the example table shows M x N values. Note that some example parameters, e.g. the “valve position” and “auto-pilot mode” parameters, have Boolean values 0 and 1.

Attention is now drawn to FIG. 7, schematically illustrating a generalized view of an example of labeled data, in accordance with some embodiments of the presently disclosed subject matter. The figure provides a more detailed example 600 of labeled data 115. Additional disclosure concerning the labeling 870 process is presented herein with reference to FIGS. 1 and 8B.

Example data table 700 includes the example data table 600 of FIG. 6, representing unlabeled data 110. However, data table 700 includes, in addition, label data 750, representing labels 146. In some examples, labels 146 are the quantitative indications 144 of occurrence of TEs or other events 250 to be predicted. In the example, unlabeled data 600 combined with label data 750 comprise labeled data table 700.

In the example, the label data 750 comprise probabilities of events 250 1 through r to be predicted, e.g. pTE1 though pTEr of Top Event failures of an FTA 140. As disclosed above, in some examples, for each timestamp Ti there is set of corresponding labels such as pTE1 through pTEr associated with that data time. In some examples, the pTEx of timestamp Ti can be usable as a diagnostic tool for the first unlabeled data 110 associated with timestamp Ti. Also note, as disclosed above, that sometimes a pTEx is associated with a plurality of timestamps Ti.

Note that a table is disclosed in FIGS. 6 and 7, as a non-limiting simplified example of a data structure for labeled and unlabeled data, only for clarity of exposition. Other data structures and data representations are of course possible.

Attention is now drawn to FIG. 8A, illustrating one example of a generalized flow chart diagram, of a flow of a process or method 800, for training of anomaly detection models, in accordance with certain embodiments of the presently disclosed subject matter. This process is, in some examples, carried out by systems such as those disclosed with reference to FIGS. 3. An example data flow for method 800 is disclosed above with reference to FIG. 4A.

The flow starts at 810. According to some examples, data associated with a system and its behavior and performance is collected, e.g. from sensors 380 (block 810). This is done, in some examples, by system sensors 380 acquiring or recording the data, and then sending it to processor 320, of processing circuitry 310 of event prediction system 305, via input interface 360.

According to some examples, the collected data is split into several data sets (block 815). In some examples, this is performed by a module (not shown) of processor 320, of processing circuitry 310. For example, the collected data may be split into the three data sets first unlabeled data 110, the second unlabeled data 410 and the third unlabeled data 560. As indicated above with reference to FIG. 1, this step does not occur in some example cases.

According to some examples, associations between each BE or other input events 260, and data sources such as 461, 462, are defined (block 818). This step is in some examples performed by engineering staff. In some examples, such an association will enable the correct inputs (training data sets) to train each corresponding anomaly detection model 120-x. This definition will enable the indication 425 of the occurrence of each input event 260 (or in some cases each sub-set of the input events), generated 133 and output by a model, to be based on specific items of the first unlabeled data 110, e.g. on sensor data that is associated with a sub-set of sensors 380. More details on such definition is disclosed above with reference to FIG. 4C.

According to some examples, the Machine Learning Anomaly Detection Model(s) 120 is trained 118 (block 820). In some examples, the training118 utilizes second unlabeled data 410, e.g. collected in block 810. In some examples, this training is unsupervised. In some examples, second unlabeled data 410 function as a training set for the model training. In some examples, this block utilizes Anomaly Detection Training Module 312.

According to some examples, trained Machine Learning Anomaly Detection Models 120 are thereby generated (block 825).

Attention is now drawn to FIG. 8B, illustrating one example of a generalized flow chart diagram, of a flow of a process or method 832, for generation of data labels, in accordance with certain embodiments of the presently disclosed subject matter. This process is, in some examples, carried out by systems such as those disclosed with reference to FIGS. 3. An example data flow for method 832 is disclosed above with reference to FIGS. 4B, 4C.

The example process flow 832 corresponds to the two-traversal implementation (a qualitative/logical traversal followed by a quantitative/probabilistic traversal) disclosed with reference to FIG. 4D. A modified process flow, which for example deletes or modifies blocks 855, 860, can, in some examples, apply mutatis mutandis to the single-traversal implementation (a quantitative/probabilistic traversal only), also disclosed with reference to FIG. 4D.

The flow starts at 830. According to some examples, first unlabeled data 110 is input 127 to the one or more trained Machine Learning Anomaly Detection Models 120 (block 830). This is done, in some examples, by processor 320, of processing circuitry 310 of event prediction system 305. In some examples, this block utilizes Anomaly Detection Module 314.

According to some examples, indications 425, 481, 482, 489 of occurrence of input event(s) 260 are generated 133, 423 (block 835). One example of input events 260 is Basic Events BEx. In some examples, this step is performed utilizing Anomaly Detection Module 314 and trained Machine Learning Anomaly Detection Model(s) 120 of. In some examples, this is performed based on the first unlabeled data 110.

According to some examples, data-based factors 426 are generated (block 837). In some examples, this is performed by factor derivation module 325 of processor 320. In some examples, this generation is based on the indications of occurrence 425, 481, 482, 489 of input event(s) 260, and on first unlabeled data 110. In some examples, these factors 426 correspond respectively with the indications 425, 481, 482, 489 of occurrence of input event(s) 260. More details on the generation and use of data-based factors 426 are disclosed above with reference to FIG. 4D.

According to some examples, indications 425, 481, 482, 489, of the occurrence of the one or more input events, are input into the one or more Analysis Tools 140 (block 850). In some examples, this is performed utilizing analysis module 319 of processor 320.

According to some examples, indications 442, 444 of occurrence of the one or more events 250 to be predicted are generated 441, 443 (block 855). An example of events 250 to be predicted is Top Events 250. In some examples, this is performed using the RAMS Analysis Tool(s) 140 and analysis module 319 of processor 320. Blocks 850 and 855 in some examples correspond to the first traversal of Tool(s) 140, considering the qualitative or logical/Boolean aspect of Tool(s) 140, as disclosed with reference to FIG. 4D.

According to some examples, the default 432 first probabilities of occurrence of the input event(s) 260 are modified, based on corresponding data-based factors 426 (block 857). In some examples, updated first probabilities of occurrence of the event(s) 260 are thereby derived. In some examples, this is performed by factor derivation module 325, or by some other component or module of processor 320. More details on this process are disclosed above with reference to FIG. 4D.

According to some examples, the indications 442, 444, of occurrence of the event(s) 250 to be predicted, are input 447 into the RAMS Analysis Tool(s) 140 (block 860). As disclosed above with reference to FIG. 4D, in some examples the indications 442, 444 are referred to herein also as final activation results 442, 444. In some examples, this block utilizes analysis module 319.

According to some examples, quantitative inputs are input 427, 437 into the RAMS Analysis Tool(s) 140 (block 862). Examples of these quantitative inputs include default 432 first probabilities of occurrence of the input event(s) 260, updated first probabilities of occurrence of the event(s) 260 (e.g. derived in block 857), and/or data-based factors 426. In some examples, this block utilizes analysis module 319. Different possible implementations of inputting, and of utilizing, these quantitative inputs are disclosed with reference to FIGS. 2 and 4D.

According to some examples, quantitative indications 144, 430, 435, of events 250 to be predicted, are generated and output 431, 433 (block 865). Examples of such events 250 include Top Events TEx. In some examples, these quantitative indications are probabilities, e.g. pTEx. In some examples this is performed using Analysis Tool(s) 140 and analysis module 319.

In some examples, this generation is performed only with respect to those events 250 to be predicted that are associated with positive indications 442, 444 of occurrence of the event(s) 250. That is, as disclosed above with reference to FIG. 4D, in some examples Tool 140 generates the quantitative indications 430, 435 only with respect to those events 250 to be predicted for which the indications 442 of occurrence are equal to 1 or Yes.

Blocks 860, 862 and 865 in some examples correspond to the second traversal of Tool(s) 140, considering the qualitative or probabilistic aspect of Tool(s) 140, as disclosed with reference to FIG. 4D.

According to some examples, labels 146 are generated for the first unlabeled data 110 (block 870). In some examples first labeled data 115 is thereby derived from the first unlabeled data 110. In some examples, this is performed using Data Labelling Module 330 of processor 320. In some examples, the label generation is performed using the quantitative indications 144, 430, 435 of the TEs or other events 250 to be predicted. In some examples, the labels are an output of tool(s) 140.

Note that the above is one non-limiting flow 832 for this implementation of the label generation process. In other examples, blocks can be added/deleted/modified, and/or their order changed. As a non-limiting example, in some cases block 837 is performed after block 855.

Attention is now drawn to FIG. 9A, illustrating one example of a generalized flow chart diagram, of a flow of a process or method 900, for training of models, in accordance with certain embodiments of the presently disclosed subject matter. This process is, in some examples, carried out by systems such as those disclosed with reference to FIGS. 3. An example data flow for method 900 is disclosed above with reference to FIG. 5A.

The flow starts at 905. According to some examples, first labeled data 115 is received and input 156 to one or more Machine Learning Event Prediction Models 160 (block 905). This is done, in some examples, by event prediction training module 316 of processor 320, of processing circuitry 310 of event prediction system 305. First labeled data 115 is associated with a system (e.g. an engine or a landing gear) which is being analyzed. In some examples, first labeled data 115 function as a training set for the model training.

According to some examples, one or more Machine Learning Event Prediction Models 160 are trained (block 910). This is done, in some examples, utilizing event prediction training module 316. In some examples, this training is based on, and utilizes, first labeled data 115.

According to some examples, one or more trained Machine Learning Event Prediction Models 160 are generated (block 920). This is done, in some examples, utilizing event prediction training module 316.

Attention is now drawn to FIG. 9B, illustrating one example of a generalized flow chart diagram, of a flow of a process or method 950, for event prediction, in accordance with certain embodiments of the presently disclosed subject matter. This process is, in some examples, carried out by systems such as those disclosed with reference to FIGS. 3. An example data flow for method 950 is disclosed above with reference to FIG. 5B.

The flow starts at 960. According to some examples, third unlabeled data 560 is received and input 163 into the one or more trained Machine Learning Event Prediction Models 160 (block 905). This is done, in some examples, utilizing event prediction module 318 of processor 320, of processing circuitry 310 of event prediction system 305. In some examples, third labeled data 560 is operational data 560 associated with a system (e.g. an airplane or an airplane engine) which is being analyzed.

According to some examples, predicted third probabilities 180, of occurrence of the event(s) 250 to be predicted, are generated (block 965). This is done, in some examples, utilizing trained Machine Learning Event Prediction Model(s) 160, of processor 320. In some examples, this block utilizes event prediction module 318. In some examples, the predictions are generated and derived based at least on third unlabeled data 560. In some examples, there are predicted probabilities 180 of each predicted event 250 (e.g. each TE) for given times. In some examples, for a given time, e.g. 2 years from now, a predicted probability 180 is generated for each predicted event 250.

Once the predicted probabilities 180 are generated, in some examples, there are more than one possible actions. Three non-limiting example actions are now disclosed.

According to some examples, the predicted third probabilities 180 are output (block 970). This is done, in some examples, by processor 320, using e.g. output interfaces 370 to output the third probabilities 180 to output devices 390.

According to some examples, the engineering or operations staff plan maintenance (e.g. predictive maintenance), operations and logistics, based on the output third probabilities 180 (block 980). This block is based on the output of block 970. Additional detail of such activities, and their impact on the frequency of performing all or part of methodology 100, are disclosed further herein.

In some other examples, as indicated above, the predicted probability 180 is generated for an event time interval of minutes or hours from now. This can allow for other uses of the generated predicted probability 180, as is now disclosed regarding blocks 990 and 995. In some examples, these blocks disclose real-time or near-real time actions.

According to some examples, an alert is sent an external system 390 (block 990). For example, the alert can indicate the relevant generated third probabilities 180. In some examples, this block utilizes Alerts and Commands Module 332. In one example, the alert is sent to a system of an operator of the analyzed system, e.g. a pilot of an airplane. For example, the pilot’s external system 390 receives an alert that Engine #2 is predicted to fail in two hours, with a probability of 50%. This alert can be used by the pilot to decide to change the flight plan and land the plane at the nearest airport. The alert can in some cases also include such recommendations, e.g. “Land at nearest airport”.

In other examples of such an alert, the alert is sent to a system that does not comprise the system being analyzed. For example, the alert can be sent to ground-based system 390, associated with e.g. a control center. Control personnel see the alert, and can e.g. contact or inform the pilot, or other operator of the analyzed system, that certain actions should be taken.

According to some examples, an action command is sent an external system 390 (block 995). In some examples, this block utilizes Alerts and Commands Module 332. In such a case, external systems 390 comprise systems that are located on or associated with the analyzed system, e.g. an airplane. These systems receive the action commands and perform actions based on those commands, e.g. using per se known methods. In one such case, external systems 390 is located on the airplane, and is connected or otherwise associated with a controller or other control system, e.g. a navigation system. In some examples, the analyzed system is part of an autonomous vehicle, e.g. the engine of an Unmanned Aerial Vehicle (UAV). A non-limiting example of external systems 390 is an autopilot system.

The action command is in some cases indicative of the predicted probabilities 180. For example, the action command can in some cases be sent together with prediction information that caused Alerts and Commands Module 332 to issue the command.

The action command in one illustrative example is an instruction to the navigation system to immediately begin navigation of the airplane to the nearest airport. The instruction to begin navigation can in some cases include the information that Landing Gear #1 is predicted to fail in 15 minutes, with a 70% probability.

In some other examples, the information indicative of predicted probabilities 180 is sent to external systems 390, without sending an action command. The external system(s) 390 then analyzes this information in an automated fashion and generate actions, e.g. using per se known methods.

In some implementations, the event prediction system 305 can perform more than one such block, i.e. blocks 970, 980, 990 and/or 995.

Note that in some cases, blocks 990 and/or 995 can be combined with block 970. the sending of th alerts or action commands can be considered in some case an output, per block 970.

Reverting now to block 980, in some examples, maintenance activities and tasks can be planned at the correct time and cost. That is, the predicted probabilities of events such as failures can serve as one input to maintenance decision, along with cost considerations such as staff availability etc.

In some examples, engineering or operations staff can plan or perform optimization of operations. For example, depending on predicted probabilities of a TE, e.g. a system failure, it may be decided that Airplane 3 should fly more or fewer hours per day than it is currently flying. That is, in some examples, it may be planned to subject the particular system to more or less intensive use.

In some examples, engineering or operations staff can plan or perform optimization of logistics. For example, ordering of spare or replacement parts can be performed on a Just In Time (JIT) basis.

In all of the above examples, the prediction 180 of a future event 250 can serve as an input to decision making, that is it enables decision-making support.

As disclosed above, in some cases the above methodologies provide at least the example advantage of enabling prediction 180 of a future event 250 such as a failure (e.g. predicting the probability of the event for a given time of occurrence), in an amount of time ahead of the event sufficient for the business needs of the system user, based only on field data 110 collected from the systems being analyzed. In some examples, users of the methodologies, processes and systems disclosed herein are able to predict a failure or other system event 250 before it occurs, and thus will be able to perform close monitoring of the relevant systems. “Unexpected” failures and “unnecessary” maintenance actions can in some examples be avoided, using such a prediction methodology 100. In some examples, the system’s Life Cycle (LC) and deterioration are directly impacted by the benefits of a predictive maintenance policy such as enabled by FIGS. 8A, 8B, 9A, 9B. Example advantages, for e.g. the airline industry, are disclosed further above.

In some examples, the methodology 100 can be described as “train once, use operationally many times”. That is, a certain quantity or amount of second unlabeled data 410 and first unlabeled data 110 is collected, model(s) 120 is trained, the results 133 are input 135 to analysis tool(s) 140, and labels 146 are derived. The second model(s) 160is trained 158 based on first labeled data 115. The trained prediction model(s) 160 can then be used multiple times going forward, to derive predictions 180 for failures/events 250 of a system for each set of collected and input operational third unlabeled data 560 - in some cases using the same trained model(s) 160 for prediction of events 250 relating to multiple instances of an investigated system.

In other examples, the models training 118, 158, and the labels generation process, of e.g. FIGS. 4 and FIG. 5A. are performed more than once over time, in some cases in an ongoing manner. In one example of this, as more and more operational data, from sensors etc., are collected, the models 120, 160 can be trained on a continual basis, e.g. at defined time intervals, using all or parts of the methodology 100. Similarly, new labels 115 are generated. The training based on increasingly large data sets can in some case improve the model(s).

In another example, a consideration is that systems deteriorate over time, as they are used continually. After e.g. several years of operation of an aircraft, the measured sensor data and other data 110 for the same instance of an analyzed system may be different, and thus may appear anomalous, relative to the anomaly detection model 120 that was trained at an earlier time. Thus, a retraining of model 120 may be required at various points in time. This in some cases thus results in a different first labeled data set 115, which in turn can require a re-training of prediction model 160 at various points in time.

Similarly, in some examples, for each instance of a particular system, a separate training of models 120, 160 may be required. For example, in some cases two airplane engines of model X, may be able to use a single trained prediction model 160 for prediction, when they are initially manufactured and installed in a certain model Y of airplane. However, after a certain amount of time, a separate re-training process may be required for each of the two instances, based on the collected data 110, 410, 560 of each. Such separate retraining may be required because sub-systems of each of the two engines may be different from each other, and each thus instance may be unique. For example, each instance of the Model X engine may deteriorate in different ways, and at different rates. One example reason for this is that each is used in different weather and environmental conditions - e.g. Engine 1 is used to fly mostly to cold Alaska, for five hours a day, while Engine 2 is used to fly mostly over the hot Sahara Desert, for only one hour a day, and/or they operate at different altitudes. In addition, each instance of the system has different components replaced, repaired or maintained, at differing points in time, i.e. has a different service history. For example, Engine 1 had a turbine replaced after six months, while Engine 2 had a major repair of its electrical sub-systems after eleven months.

Thus, for at least reasons such as the above, in some examples the methodology 100 disclosed with reference to FIGS. 4 and FIG. 5A (a) is performed separately for each instance of a system that is being analyzed, and (b) the methodology 100, or parts of it, is repeated. This repetition is performed for example, at or after certain defined intervals or points in time, and after certain major events, such as a system repair, system overhaul, or a system accident or other failure, associated with the system being analyzed.

In still other examples, during a first period of time, when the behavior of the system to be analyzed and of its sub-systems is relatively stable, the models 120, 160 can be trained on a continual basis, as more and more operational data are collected, and new labels 115 generated, using all or parts of the methodology 100, so as to improve the models. During a second period of time, during which the analyzed systems and sub-systems deteriorate or degrade, re-training and relabeling, using all or parts of the methodology 100, are repeated, after certain defined intervals, and after certain major events, in order to account for the system degradation. In some cases, this repetition of the methodology is performed separately per instance of the analyzed system(s).

Note that the above description of processes 800, 832, 900, 950 is a non-limiting example only.

In some embodiments, one or more steps of the flowchart exemplified herein may be performed automatically. The flow and functions illustrated in the flowchart figures may for example be implemented in system 305 and in processing circuitry 320, and may make use of components described with regard to FIGS. 3. It is also noted that whilst the flowchart is described with reference to system elements that realize steps, such as for example systems 305, and processing circuitry 320, this is by no means binding, and the operations can be carried out by elements other than those described herein.

It is noted that the teachings of the presently disclosed subject matter are not bound by the flowcharts illustrated in the various figures. The operations can occur out of the illustrated order. One or more stages illustrated in the figures can be executed in a different order and/or one or more groups of stages may be executed simultaneously. For example, steps 860 and 862, shown in succession, can be executed substantially concurrently, or in a different order. For example, in some cases block 837 is performed after block 855.

Similarly, some of the operations or steps can be integrated into a consolidated operation, or can be broken down into several operations, and/or other operations may be added. As a non-limiting example, in some cases blocks 860 and 862 can be combined.

In embodiments of the presently disclosed subject matter, fewer, more and/or different stages than those shown in the figures can be executed. As one non-limiting example, certain implementations may not include the blocks 855, 860.

In the claims that follow, alphanumeric characters and Roman numerals, used to designate claim elements such as components and steps, are provided for convenience only, and do not imply any particular order of performing the steps.

It should be noted that the word “comprising” as used throughout the appended claims, is to be interpreted to mean “including but not limited to”.

While there has been shown and disclosed examples in accordance with the presently disclosed subject matter, it will be appreciated that many changes may be made therein without departing from the spirit of the presently disclosed subject matter.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter may be, at least partly, a suitably programmed computer. Likewise, the presently disclosed subject matter contemplates a computer program product being readable by a machine or computer, for executing the method of the presently disclosed subject matter, or any part thereof. The presently disclosed subject matter further contemplates a non-transitory machine-readable or computer-readable memory tangibly embodying a program of instructions executable by the machine or computer for executing the method of the presently disclosed subject matter or any part thereof. The presently disclosed subject matter further contemplates a non-transitory computer readable storage medium having a computer readable program code embodied therein, configured to be executed so as to perform the method of the presently disclosed subject matter.

Those skilled in the art will readily appreciate that various modifications and changes can be applied to the embodiments of the invention as hereinbefore described without departing from its scope, defined in and by the appended claims.

1. A computerized system configured to perform training of machine learning models to enable prediction of occurrence of one or more events to be predicted, the one or more events to be predicted being associated with a system to be analyzed, the computerized system comprising a processing circuitry configured to perform the following:
a. provide one or more trained Machine Learning Anomaly Detection Models;
b. provide one or more Analysis Tools, configured to provide quantitative indications of the one or more events to be predicted,
wherein each event to be predicted of the one or more events is associated with one or more input events,
wherein the quantitative indications of the one or more events to be predicted are based on the one or more input events;
c. receive first unlabeled data associated with the system to be analyzed, wherein the first unlabeled data comprises at least sensor data associated with one or more sensors;
d. input the first unlabeled data to the one or more trained Machine Learning Anomaly Detection Models;
e. generate, using the one or more trained Machine Learning Anomaly Detection Models, indications of occurrence of the one or more input events, based on the first unlabeled data;
f. input the indications of the occurrence of the one or more input events into the one or more Analysis Tools;
g. generate, using the one or more Analysis Tools, quantitative indications of the one or more events to be predicted, based at least on the indications of the occurrence of the one or more input events; and
h. generate, using the quantitative indications of the one or more events to be predicted, labels for the first unlabeled data, thereby deriving first labeled data from the first unlabeled data,
whereby the first labeled data is usable to enable training one or more Machine Learning Event Prediction Models associated with the system to be analyzed, wherein the one or more trained Machine Learning Event Prediction Models are configured to predict, based on third unlabeled data, predicted third probabilities of occurrence of the one or more events to be predicted, wherein each predicted third probability of the third probabilities is associated with a predicted time of the occurrence of the event.

2. The computerized system of the previous claim, wherein the quantitative indications of the one or more events to be predicted comprise second probabilities of occurrence of the one or more events to be predicted.

3. The computerized system of any one of claims 1 to 2, wherein the indications of the occurrence of the one or more input events comprise Boolean values.

4. The computerized system of any one of claims 1 to 3, wherein the indications of the occurrence of the one or more input events are associated with indications of anomalies in the first unlabeled data.

5. The computerized system of any one of claims 1 to 4, wherein the first unlabeled data is associated with a timestamp, and the probabilities of occurrence of the one or more events to be predicted are associated with the timestamp.

6. The computerized system of the previous claim, wherein a single indication of occurrence of the one or more input events is associated with a plurality of timestamps,
wherein a single quantitative indication of the one or more events to be predicted is associated with the plurality of timestamps.

7. The computerized system of any one of claims 1 to 6, wherein each input event of the one or more input events is associated with a trained Machine Learning Anomaly Detection Model of the one or more trained Machine Learning Anomaly Detection Models.

8. The computerized system of any one of claims 1 to 7, wherein the first unlabeled data comprises condition parameters data, associated with at least one of characteristics of the system to be analyzed and characteristics of system operation.

9. The computerized system of the previous claim, wherein the condition parameters data comprises data deriving from within the system to be analyzed and data deriving from without the system.

10. The computerized system of any one of claims 1 to 9, wherein the one or more trained Machine Learning Anomaly Detection Models are configured such that an indication of the occurrence of each input event of the one or more input events is based on sensor data associated with a sub-set of the one or more sensors.

11. The computerized system of the previous claim, wherein the configuration of the one or more trained Machine Learning Anomaly Detection Models is based on the one or more Analysis Tools.

12. The computerized system of any one of claims 1 to 11, wherein the first unlabeled data, the second unlabeled data and the third unlabeled data are distinct portions of a single data set.

13. The computerized system of any one of claims 1 to 12, wherein the one or more analysis Tools comprise default first probabilities of occurrence of the one or more input events,
wherein said step (g) is further based at least on the on the default first probabilities of occurrence of the one or more input events.

14. The computerized system of the previous claim, wherein the default first probabilities of occurrence of the one or more input events are input into the one or more analysis Tools.

15. The computerized system of any one of claims 13 to 14,
wherein the step (e) further comprises generating, based on the indications of occurrence of the one or more input events and the first unlabeled data, data-based factors corresponding respectively with the indications of occurrence of the one or more input events,
wherein the step (g) comprises modifying the default first probabilities of occurrence of the one or more input events, based on corresponding data-based factors, thereby deriving updated first probabilities of occurrence of the one or more input events.

16. The computerized system of any one of claims 1 to 15, wherein the one or more Analysis Tools are further configured to provide qualitative indications of the one or more events to be predicted.

17. The computerized system of the previous claim, wherein the qualitative indications of the one or more events to be predicted comprise indications of occurrence of the one or more events to be predicted, wherein the step (g) comprises:
(i) generating, using the one or more Analysis Tools, the indications of occurrence of the one or more events to be predicted;
(ii) inputting the indications of occurrence of the one or more events to be predicted into the one or more Analysis Tools; and
(iii) performing the generating of the quantitative indications of the one or more events to be predicted in respect of events to be predicted that are associated with positive indications of occurrence of the one or more events to be predicted.

18. The computerized system of the previous claim, wherein the indications of occurrence of the one or more events to be predicted comprise Boolean values.

19. The computerized system of any one of claims 1 to 18, wherein each predicted third probability of the predicted third probabilities is associated with a given time of the occurrence.

20. The computerized system of any one of claims 1 to 19,
wherein the one or more Machine Learning Event Prediction Models comprises one or more Machine Learning Failure Prediction Models,
wherein the one or more trained Machine Learning Event Prediction Models comprises one or more trained Machine Learning Failure Prediction Models.

21. The computerized system of any one of claims 1 to 20, wherein the step (a) comprises:
training one or more Machine Learning Anomaly Detection Models, utilizing second unlabeled data, thereby generating the one or more trained Machine Learning Anomaly Detection Models.

22. The computerized system of any one of claims 1 to 20, wherein the one or more Machine Learning Anomaly Detection Models comprises at least one of a One Class Classification Support Vector Machine (OCC SVM), a Local Outlier Factor (LOF), and a One Class Classification Random Forest (OCC RF).

23. The computerized system of any one of claims 1 to 22, wherein the one or more Machine Learning Event Prediction Models comprises at least one of a Bayesian network and a Deep Neural Network.

24. The computerized system of any one of claims 1 to 23, wherein the Analysis Tool comprises Event Tree Analysis.

25. The computerized system of any one of claims 1 to 24, wherein the one or more events to be predicted comprise one or more failures.

26. The computerized system of any one of claims 1 to 25, wherein the one or more Analysis Tools comprises one or more Reliability, Availability, Maintainability and Safety (RAMS) Analysis Tools.

27. The computerized system of the previous claim, wherein the RAMS Analysis Tool comprises Failure Tree Analysis.

28. The computerized system of any one of claims 1 to 27, wherein the one or more events to be predicted are based on logic combinations of input events.

29. The computerized system of any one of claims 1 to 28, wherein the one or more events to be predicted comprise one or more Top Events.

30. The computerized system of any one of claims 1 to 29, wherein the one or more input events comprise one or more Basic Events.

31. The computerized system of any one of claims 1 to 30, wherein the processing circuitry further configured to perform a repetition of steps (a) to (h).

32. The computerized system of the previous claim, wherein the performance of the repetition is after at least one of a defined time interval, a system repair, a system overhaul and a system failure.

33. A computerized system configured to perform predict occurrence of one or more events to be predicted, the one or more events to be predicted being associated with a system to be analyzed, the computerized system comprising a processing circuitry configured to perform the following:
a. input third unlabeled data into one or more trained Machine Learning Event Prediction Models,
wherein the one or more trained Machine Learning Event Prediction Models are generated by performing the following:
i. provide one or more trained Machine Learning Anomaly Detection Models;
ii. provide one or more Analysis Tools, configured to provide quantitative indications of the one or more events to be predicted,
wherein each event to be predicted of the one or more events is associated with one or more input events,
wherein the quantitative indications of the one or more events to be predicted are based on one or more input events;
iii. receive first unlabeled data associated with the system to be analyzed, wherein the first unlabeled data comprises at least sensor data associated with one or more sensors;
iv. input the first unlabeled data to the one or more trained Machine Learning Anomaly Detection Models;
v. generate, using the one or more trained Machine Learning Anomaly Detection Models, indications of occurrence of the one or more input events, based on the first unlabeled data;
vi. input the indications of the occurrence of the one or more input events to the one or more Analysis Tools;
vii. generate, using the one or more Analysis Tools, quantitative indications of occurrence of the one or more events to be predicted, based at least on the indications of the occurrence of the one or more input events;
viii. generate, using the quantitative indications of the one or more events to be predicted, labels for the first unlabeled data, thereby deriving first labeled data from the first unlabeled data; and
ix. train one or more Machine Learning Event Prediction Models associated with the system to be analyzed, utilizing the first labeled data, thereby generating the one or more trained Machine Learning Event Prediction Models; and
b. generate, using the one or more trained Machine Learning Event Prediction Models, predicted third probabilities of occurrence of the one or more events to be predicted, based on the third unlabeled data,
wherein each predicted third probability of the third probabilities is associated with a predicted time of the occurrence of the event; and
c. output the predicted third probabilities.

34. The computerized system of the previous claim, wherein the computerized system is operatively coupled to at least one external system, wherein the outputting of the predicted third probabilities comprises at least one of: sending an alert to at least one external system, sending an action command to the at least one external system.

35. The computerized system of any one of claims 1 to 34, wherein the system to be analyzed is one of an aircraft system and a spacecraft system.

36. A method of training machine learning models to enable prediction of occurrence of one or more events to be predicted, the one or more events to be predicted being associated with a system to be analyzed, comprising, using a processing circuitry to perform the following:
a. provide one or more trained Machine Learning Anomaly Detection Models;
b. provide one or more Analysis Tools, configured to provide quantitative indications of the one or more events to be predicted,,
wherein each event to be predicted of the one or more events is associated with one or more input events,
wherein the quantitative indications of the one or more events to be predicted are based on the one or more input events;
c. receive first unlabeled data associated with the system to be analyzed, wherein the first unlabeled data comprises at least sensor data associated with one or more sensors;
d. input the first unlabeled data to the one or more trained Machine Learning Anomaly Detection Models;
e. generate, using the one or more trained Machine Learning Anomaly Detection Models, indications of occurrence of the one or more input events, based on the first unlabeled data;
f. input the indications of the occurrence of the one or more input events into the one or more Analysis Tools;
g. generate, using the one or more Analysis Tools, quantitative indications of the one or more events to be predicted, based at least on the indications of the occurrence of the one or more input events; and
h. generate, using the quantitative indications of the one or more events to be predicted, labels for the first unlabeled data, thereby deriving first labeled data from the first unlabeled data,
whereby the first labeled data is usable to enable training one or more Machine Learning Event Prediction Models associated with the system, wherein the one or more trained Machine Learning Event Prediction Models are configured to predict, based on third unlabeled data, predicted third probabilities of occurrence of the one or more events to be predicted, wherein each predicted third probability of the third probabilities is associated with a predicted time of the occurrence of the event.

37. The computerized method of claim 36, wherein the indications of the occurrence of the one or more input events comprise Boolean values.

38. The method of any one of claims 36 to 37, wherein the indications of the occurrence of the one or more input events are associated with indications of anomalies in the first unlabeled data.

39. The method of any one of claims 36 to 38, wherein each input event of the one or more input events is associated with a trained Machine Learning Anomaly Detection Model of the one or more trained Machine Learning Anomaly Detection Models.

40. The method of any one of claims 36 to 39, wherein the step (a) comprises:
training one or more Machine Learning Anomaly Detection Models, utilizing second unlabeled data, thereby generating the one or more trained Machine Learning Anomaly Detection Models.

41. The method of any one of claims 36 to 40, wherein the one or more Analysis Tools comprises one or more Reliability, Availability, Maintainability and Safety (RAMS) Analysis Tools.

42. The method of the previous claim, wherein the RAMS Analysis Tool comprises Failure Tree Analysis.

43. The method of any one of claims 36 to 32, wherein the one or more events to be predicted comprise one or more Top Events.

44. The method of any one of claims 36 to 32, wherein the one or more input events comprise one or more Basic Events.

45. A method of predicting occurrence of one or more events to be predicted, the one or more events to be predicted being associated with a system to be analyzed, comprising, using a processing circuitry to perform the following:
a. input third unlabeled data into one or more trained Machine Learning Event Prediction Models,
wherein the one or more trained Machine Learning Event Prediction Models are generated by performing the following:
i. provide one or more trained Machine Learning Anomaly Detection Models;
ii. provide one or more Analysis Tools, configured to provide quantitative indications of the one or more events to be predicted,
wherein each event to be predicted of the one or more events is associated with one or more input events,
wherein the quantitative indications of the one or more events to be predicted are based on one or more input events;
iii. receive first unlabeled data associated with the system to be analyzed, wherein the first unlabeled data comprises at least sensor data associated with one or more sensors;
iv. input the first unlabeled data to the one or more trained Machine Learning Anomaly Detection Models;
v. generate, using the one or more trained Machine Learning Anomaly Detection Models, indications of occurrence of the one or more input events, based on the first unlabeled data;
vi. input the indications of the occurrence of the one or more input events to the one or more Analysis Tools;
vii. generate, using the one or more Analysis Tools, quantitative indications of occurrence of the one or more events to be predicted, based at least on the indications of the occurrence of the one or more input events;
viii. generate, using the quantitative indications of the one or more events to be predicted, labels for the first unlabeled data, thereby deriving first labeled data from the first unlabeled data; and
ix. train one or more Machine Learning Event Prediction Models associated with the system to be analyzed, utilizing the first labeled data, thereby generating the one or more trained Machine Learning Event Prediction Models; and
b. generate, using the one or more trained Machine Learning Event Prediction Models, predicted third probabilities of occurrence of the one or more events to be predicted, based on the third unlabeled data,
wherein each predicted third probability of the third probabilities is associated with a predicted time of the occurrence of the event; and
c. output the predicted third probabilities.

46. A non-transitory computer readable storage medium tangibly embodying a program of instructions that, when executed by a computer, cause the computer to perform a method of training machine learning models to enable prediction of occurrence of one or more events to be predicted, the one or more events to be predicted being associated with a system to be analyzed, the method being performed by a processing circuitry and comprising performing the following:
a. provide one or more trained Machine Learning Anomaly Detection Models;
b. provide one or more Analysis Tools, configured to provide quantitative indications of the one or more events to be predicted,
wherein each event to be predicted of the one or more events is associated with one or more input events,
wherein the quantitative indications of the one or more events to be predicted are based on the one or more input events;
c. receive first unlabeled data associated with the system to be analyzed, wherein the first unlabeled data comprises at least sensor data associated with one or more sensors;
d. input the first unlabeled data to the one or more trained Machine Learning Anomaly Detection Models;
e. generate, using the one or more trained Machine Learning Anomaly Detection Models, indications of occurrence of the one or more input events, based on the first unlabeled data;
f. input the indications of the occurrence of the one or more input events into the one or more Analysis Tools;
g. generate, using the one or more Analysis Tools, quantitative indications of the one or more events to be predicted, based at least on the indications of the occurrence of the one or more input events; and
h. generate, using the quantitative indications of the one or more events to be predicted, labels for the first unlabeled data, thereby deriving first labeled data from the first unlabeled data, whereby the quantitative indications of the one or more events to be predicted are usable as a diagnostic tool for the first unlabeled data,
whereby the first labeled data is usable to enable training one or more Machine Learning Event Prediction Models associated with the system to be analyzed, wherein the one or more trained Machine Learning Event Prediction Models are configured to predict, based on third unlabeled data, predicted third probabilities of occurrence of the one or more events to be predicted, wherein each predicted third probability of the third probabilities is associated with a predicted time of the occurrence of the event.

47. The non-transitory computer readable storage medium of claim 46, wherein the indications of the occurrence of the one or more input events are associated with indications of anomalies in the first unlabeled data.

48. The non-transitory computer readable storage medium of any one of claims 46 to 47, wherein the step (a) comprises:
training one or more Machine Learning Anomaly Detection Models, utilizing second unlabeled data, thereby generating the one or more trained Machine Learning Anomaly Detection Models.

49. The non-transitory computer readable storage medium of any one of claims 46 to 48, wherein the one or more Analysis Tools comprises one or more Reliability, Availability, Maintainability and Safety (RAMS) Analysis Tools.

50. A non-transitory computer readable storage medium tangibly embodying a program of instructions that, when executed by a computer, cause the computer to perform a method of predicting occurrence of one or more events to be predicted, the one or more events to be predicted being associated with a system to be analyzed, the method being performed by a processing circuitry and comprising performing the following:
a. input third unlabeled data into one or more trained Machine Learning Event Prediction Models,
wherein the one or more trained Machine Learning Event Prediction Models are generated by performing the following:
i. provide one or more trained Machine Learning Anomaly Detection Models;
ii. provide one or more Analysis Tools, configured to provide quantitative indications of the one or more events to be predicted,
wherein each event to be predicted of the one or more events is associated with one or more input events,
wherein the quantitative indications of the one or more events to be predicted are based on one or more input events;
iii. receive first unlabeled data associated with the system to be analyzed, wherein the first unlabeled data comprises at least sensor data associated with one or more sensors;
iv. input the first unlabeled data to the one or more trained Machine Learning Anomaly Detection Models;
v. generate, using the one or more trained Machine Learning Anomaly Detection Models, indications of occurrence of the one or more input events, based on the first unlabeled data;
vi. input the indications of the occurrence of the one or more input events to the one or more Analysis Tools;
vii. generate, using the one or more Analysis Tools, quantitative indications of occurrence of the one or more events to be predicted, based at least on the indications of the occurrence of the one or more input events;
viii. generate, using the quantitative indications of the one or more events to be predicted, labels for the first unlabeled data, thereby deriving first labeled data from the first unlabeled data; and
ix. train one or more Machine Learning Event Prediction Models associated with the system to be analyzed, utilizing the first labeled data, thereby generating the one or more trained Machine Learning Event Prediction Models; and
b. generate, using the one or more trained Machine Learning Event Prediction Models, predicted third probabilities of occurrence of the one or more events to be predicted, based on the third unlabeled data,
wherein each predicted third probability of the third probabilities is associated with a predicted time of the occurrence of the event; and
c. output the predicted third probabilities.
